(19) United States
(12) Patent Application Publication
(10) Pub. No.: US 2009/0115880 A1
(43) Pub. Date: May 7, 2009

(54) IMAGE PICKUP APPARATUS AND DISPLAY CONTROLLING METHOD THEREFOR

(75) Inventors: Takayuki WADA, Kawasaki-shi (JP); Shinya ISHII, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/263,449

(22) Filed: Oct. 31, 2008

(30) Foreign Application Priority Data
Nov. 2, 2007 (JP) 2007-286473
Nov. 2, 2007 (JP) 2007-286474
Nov. 21, 2007 (JP) 2007-302127

(51) Int. Cl. H04N 5/222

(52) U.S. Cl. 348/333.01; 348/E05.024

(57) ABSTRACT

An image pickup apparatus capable of improving operability in the video light mode. The image pickup apparatus images an object and comprises a first display unit adapted to display a video of the imaged object or solid white, a second display unit adapted to display a video of the imaged object, a selection unit adapted to select a video light mode of using the first display unit as a video light, and a display controlling unit adapted to change over the first display unit so as to display white and turn on the second display unit if the video light mode is selected.

### BACKGROUND OF THE INVENTION

1. Field of the Invention

The present invention relates to an image pickup apparatus adapted to image an object and a display controlling method therefor.

2. Description of the Related Art

Hitherto, various cameras serving as an image pickup apparatus have generally used a built-in light or an external light which is an outboard light detachably mounted on a camera main body as a light source for an object. There has been known that a liquid crystal panel is solidly whitened to project the light onto the object, thereby used as a video light. (for example, refer to Japanese Laid-Open Patent Publication (Kokai) No. H10-126655).

FIG. 25 is a perspective view illustrating the external appearance of a video camera as a conventional image pickup apparatus. A video camera 210 is provided with a lens 214 at the front portion of a camera main body 212, a color viewfinder 216 at the rear portion thereof and a liquid crystal monitor 218 at the side portion thereof.

The liquid crystal monitor 218 is rotatably attached to the camera main body 212 with a hinge portion 220. In case of face-to-face photographing, as illustrated in FIG. 25, the liquid crystal monitor 218 is directed to an object to cause the liquid crystal monitor 218 and the color viewfinder 216 to light at the same time. For this reason, a user can shoot the object while viewing how the object is photographed.

The liquid crystal monitor 218 includes a liquid crystal panel 224 attached to a frame 222 and a backlight 226 (refer to FIG. 26) arranged at the rear portion of the liquid crystal panel 224. This makes the liquid crystal panel 224 to act as a light emitting display.

In general, the liquid crystal panel 224 is solidly whitened (i.e., a state where a transmission factor is maximum) to maximize the quantity of light emitted from the liquid crystal panel 224, which provides the same state where a video light is projected at the object. By using the phenomenon aggressively, the video camera causes the liquid crystal monitor 218 to function as a video light.

FIG. 26 is a block diagram illustrating a configuration of a control circuit implementing the control of the liquid crystal monitor 218 in FIG. 25. The control circuit is incorporated into the camera main body 212. The control circuit includes an LCD drive circuit 201, a controlling microcomputer 202, a photographing mode detecting circuit 203, a changeover switch 204, a power supply circuit 205, an oscillating circuit 206 and an inverter transformer 207. The circuit configuration is known and characterized in that the liquid crystal monitor 218 is solidly whitened by the changeover switch 204 to use the liquid crystal monitor 218 as a video light.

Specifically, turning on the changeover switch 204 causes the photographing mode detecting circuit 203 to input a signal to the LCD drive circuit 201 through the controlling microcomputer 202 to solidly whiten the liquid crystal panel 224. This maximizes the quantity of light from the liquid crystal panel 224 and the liquid crystal panel 224 projects light onto the object and acts as a video light.

The illuminance of the backlight 226 may be increased as required to increase the quantity of light of the liquid crystal panel 224 at the time of solidly whitening the liquid crystal panel 224. More specifically, turning on the changeover switch 204 causes the controlling microcomputer 202 to input a control signal to the power supply circuit 205, increasing voltage from the power supply circuit 205. This increases the illuminance of the backlight 226. Incidentally, as the backlight 226, there may be used any type of a direct-backlight fluorescent tube or a fluorescent tube with a light-guide plate.

The conventional image pickup apparatus, however, causes the following problem when the liquid crystal panel is changed over to a solid white (video light) mode with the liquid crystal monitor directed to a shooter. In this case, the shooter can neither confirm a picked-up image nor operate a menu. For this reason, the shooter has to rotate the liquid crystal monitor to the side of the object to light the color viewfinder. In addition, when the liquid crystal panel is changed over to a solid white (video light) mode, power consumption is increased because the luminance of the backlight is increased, accelerating the consumption of a battery.

When the shooter changes over the liquid crystal monitor to the video light mode with the liquid crystal monitor directed to the shooter in a dark place, the liquid crystal panel is quickly changed over to a solid white screen with the luminance of the backlight increased to probably dazzle the shooter.

When a menu operation key is arranged on the liquid crystal monitor and the liquid crystal monitor is rotated to the side of the object, the operability is significantly lowered. When the shooter inadvertently changes over the liquid crystal panel to the video light mode, the liquid crystal panel is suddenly solidly whitened to puzzle the shooter what to do next in releasing the solid white or cause the shooter to misunderstand the liquid crystal panel is faulty.

### SUMMARY OF THE INVENTION

The present invention solves such conventional problems and provides an image pickup apparatus and a display controlling method therefor capable of improving operability in the video light mode. Furthermore, the present invention provides an image pickup apparatus and a display controlling method therefor capable of reducing dazzlement which the shooter may feel even if the liquid crystal panel is changed over to the video light mode with the liquid crystal panel directed to the shooter. Still furthermore, the present invention provides an image pickup apparatus and a display controlling method which the shooter easily understands the release of the video light mode.

According to a first aspect of the present invention, there is provided with an image pickup apparatus that images an object, comprising: a first display unit adapted to display a video of the imaged object or solid white; a second display unit adapted to display a video of the imaged object; a selection unit adapted to select a video light mode of using the first display unit as a video light; and a display controlling unit adapted to change over the first display unit so as to display white and turn on the second display unit if the video light mode is selected.

According to a second aspect of the present invention, there is provided with a display controlling method of an image pickup apparatus that images an object and that comprises a first display unit adapted to display a video of the imaged object or solid white and a second display unit adapted to display a video of the imaged object, the display controlling method comprising the steps of: selecting a video light mode of using the first display unit as a video light; and

changing over the first display unit so as to display white and turning on the second display unit if the video light mode is selected.

According to a third aspect of the present invention, there is provided with an image pickup apparatus that images an object, comprising: a display unit disposed reversible so as to be directed to the object side and adapted to display a video of the imaged object or solid white; a state detecting unit adapted to detect a reversed state where the display unit is directed to the object; a selection unit adapted to select a video light mode of using the display unit as a video light; a display controlling unit adapted to change over the display unit so as to display the solid white if the video light mode is selected; a luminance adjusting unit adapted to adjust the luminance of the display unit; and a luminance controlling unit adapted to control the luminance adjusting unit to lower the luminance of the display unit displaying the solid white as compared with the luminance of the display unit being in the reversed state if a state, except the reversed state, is detected where the display unit is not directed to the object.

According to a fourth aspect of the present invention, there is provided with an image pickup apparatus that images an object, comprising: a display unit disposed reversible so as to be directed to the object or a shooter and adapted to display the video of the imaged object or solid white; a state detecting unit adapted to detect a normal state where the display unit is directed to the shooter or a reversed state where the display unit is directed to the object; a selection unit adapted to select a video light mode of using the display unit as a video light; a display controlling unit adapted to change over the display unit so as to display the solid white if the video light mode is selected; a luminance adjusting unit adapted to adjust the luminance of the display unit; and a luminance controlling unit adapted to control the luminance adjusting unit to lower the luminance of the display unit displaying the solid white as compared with the luminance of the display unit being in the reversed state if the normal state is detected where the display unit is directed to the shooter.

According to a fifth aspect of the present invention, there is provided with an image pickup apparatus that images an object, comprising:

a display unit disposed on a main body of the image pickup apparatus openably and closably about an open and close axis and rotatably about a rotation axis perpendicular to the open and close axis and adapted to display a video of the imaged object or solid white; a state detecting unit adapted to detect a reversed and closed state where the display unit is turned about the open and close axis to be stored onto the main body from a reversed state where the display unit is directed to the object; a selection unit adapted to select a video light mode of using the display unit as a video light; a display controlling unit adapted to change over the display unit so as to display the solid white if the video light mode is selected; a luminance adjusting unit adapted to adjust the luminance of the display unit; and a luminance controlling unit adapted to control the luminance adjusting unit to lower the luminance of the display unit displaying the solid white as compared with the luminance of the display unit being in the reversed state if the reversed and closed state where the display unit is stored onto the main body is detected.

According to a sixth aspect of the present invention, there is provided with a display controlling method of an image pickup apparatus that images an object and that comprises a displaying unit disposed reversible so as to be directed to the object and adapted to display a video of the imaged object or solid white, the display controlling method comprising the steps of: detecting a reversed state where the display unit is directed to the object; selecting a video light mode of using the display unit as a video light; changing over the display unit so as to display the solid white if the video light mode is selected; adjusting the luminance of the display unit; and controlling the luminance adjusting unit to lower the luminance of the display unit displaying the solid white as compared with the luminance of the display unit being in the reversed state if a state, except the reversed state, is detected where the display unit is directed to the object.

According to a seventh aspect of the present invention, there is provided with a display controlling method of an image pickup apparatus that images an object and that comprises a displaying unit disposed reversible so as to be directed to the object and adapted to display a video of the imaged object or solid white, the display controlling method comprising the steps of: detecting a normal state where the display unit is directed to the shooter or a reversed state where the display unit is directed to the object; selecting a video light mode of using the display unit as a video light; changing over the display unit so as to display the solid white if the video light mode is selected; adjusting the luminance of the display unit; and controlling the luminance adjusting unit to lower the luminance of the display unit displaying the solid white as compared with the luminance of the display unit being in the reversed state if the normal state is detected where the display unit is directed to the shooter.

According to a eighth aspect of the present invention, there is provided with a display controlling method of an image pickup apparatus that images an object and that comprises a displaying unit disposed on a main body of the image pickup apparatus openably and closably about an open and close axis and rotatably about a rotation axis perpendicular to the open and close axis and adapted to display a video of the imaged object or solid white; the display controlling method comprising the steps of: detecting a reversed and closed state where the display unit is turned about the open and close axis to be stored onto the main body from a reversed state where the display unit is directed to the object; selecting a video light mode of using the display unit as a video light; changing over the display unit so as to display the solid white if the video light mode is selected; adjusting the luminance of the display unit; and controlling the luminance adjusting unit to lower the luminance of the display unit displaying the solid white as compared with the luminance of the display unit being in the reversed state if the reversed and closed state where the display unit is stored onto the main body is detected.

According to a ninth aspect of the present invention, there is provided with an image pickup apparatus that images an object, comprising: a display unit adapted to display a video of the imaged object or solid white; a selection unit adapted to select a video light mode of using the display unit as a video light; and a display controlling unit adapted to release the video light mode to terminate displaying of the solid white by the display unit if a specific condition occurs in a case where the video light mode is selected.

According to a tenth aspect of the present invention, there is provided with an image pickup apparatus that images an object, comprising:

a display unit adapted to display a video of the imaged object or solid white; an open and close detecting unit adapted to detect an open and close state of the display unit; a selection unit adapted to select a video light mode of using the display unit as a video light; and a display controlling unit adapted to change over the display unit so as to display the solid white if the open and close detecting unit detects that the display unit is opened in a case where the video light mode is selected, and to release the video light mode to terminate displaying of the solid white by the display unit if the open and close detecting unit detects that the display unit is closed in a case where the video light mode is selected.

According to a eleventh aspect of the present invention, there is provided with an image pickup apparatus that images an object, comprising: a display unit adapted to display a video of the imaged object or solid white; an operation detecting unit adapted to detect that a key operation is performed on the image pickup apparatus; a timing unit adapted to measure the elapsed time since the latest key operation is detected; a selection unit adapted to select a video light mode of using the display unit as a video light; and a display controlling unit adapted to change over the display unit so as to display the solid white if the video light mode is selected, and to release the video light mode to terminate displaying of the solid white by the display unit if the time measured by the timing unit exceeds a predetermined time.

According to a twelfth aspect of the present invention, there is provided with an image pickup apparatus that images an object, comprising: a display unit adapted to display a video of the imaged object or solid white; a recording medium detachably disposed in the image pickup apparatus and adapted to record the picked-up image; an ejection detecting unit adapted to detect that the recording medium is ejected to the outside; a selection unit adapted to select a video light mode of using the display unit as a video light; and a display controlling unit adapted to change over the display unit so as to display the solid white if the video light mode is selected, and to release the video light mode to terminate displaying of the solid white by the display unit if the ejection detecting unit detects that the recording medium is ejected to the outside.

According to a thirteenth aspect of the present invention, there is provided with an image pickup apparatus that images an object, comprising: a display unit adapted to display a video of the imaged object or solid white; a recording medium disposed in the image pickup apparatus and adapted to record the picked-up image; a remain capacity detecting unit adapted to detect the remain capacity of the recording medium; a selection unit adapted to select a video light mode of using the display unit as a video light; and a display controlling unit adapted to change over the display unit so as to display the solid white if the video light mode is selected, and to release the video light mode to terminate displaying of the solid white by the display unit if the remain capacity detecting unit detects that the remain capacity of the recording medium drops below a threshold value.

According to a fourteenth aspect of the present invention, there is provided with an image pickup apparatus that images an object, comprising: a display unit adapted to display a video of the imaged object or solid white; a selection unit adapted to select a video light mode of using the display unit as a video light; a display controlling unit adapted to change over the display unit so as to display the solid white if the video light mode is selected; and a superposing unit adapted to superpose contents indicating a video light mode releasing method on the changed over solid white, wherein the display controlling unit releases the video light mode to terminate displaying of the solid white by the display unit if a predetermined operation is performed in accordance with the superposed contents indicating a video light mode releasing method.

According to a fifth aspect of the present invention, there is provided with a display controlling method of an image pickup apparatus that images an object and that comprises a displaying unit adapted to display a video of the imaged object or solid white, the display controlling method comprising the steps of: selecting a video light mode of using the display unit as a video light; and releasing the video light mode to terminate displaying of the solid white by the display unit if a specific condition occurs in a case where the video light mode is selected.

According to a sixteenth aspect of the present invention, there is provided with a display controlling method of an image pickup apparatus that images an object and that comprises a displaying unit adapted to display a video of the imaged object or solid white, the display controlling method comprising the steps of: detecting an open and close state of the display unit; selecting a video light mode by the selection unit of the image pickup apparatus to use the display unit as a video light; and controlling the display by changing over the display unit so as to display the solid white if it is detected in the open and close state detecting step that the display unit is opened in a case where the video light mode is selected, and by releasing the video light mode to terminate displaying of the solid white by the display unit if it is detected in the step of detecting the open and close state that the display unit is closed in a case where the video light mode is selected.

According to a seventeenth aspect of the present invention, there is provided with a display controlling method of an image pickup apparatus that images an object and that comprises a displaying unit adapted to display a video of the imaged object or solid white, the display controlling method comprising the steps of: detecting that a key operation is performed on the image pickup apparatus; measuring the elapsed time since the latest key operation is detected; selecting a video light mode of using the display unit as a video light; and controlling the display by changing over the display unit so as to display the solid white if the video light mode is selected, and by releasing the video light mode to terminate displaying of the solid white by the display unit if the time measured by the timing unit exceeds a predetermined time.

According to a eighth aspect of the present invention, there is provided with a display controlling method of an image pickup apparatus that images an object and that comprises a displaying unit adapted to display a video of the imaged object or solid white, the display controlling method comprising the steps of: detecting that a recording medium is ejected to the outside, the recording medium being detachably disposed in the image pickup apparatus and adapted to record the picked-up image; selecting a video light mode of using the display unit as a video light; and controlling the display of changing over the display unit so as to display the solid white if the video light mode is selected, and by releasing the video light mode to terminate displaying of the solid white by the display unit if it is detected that the recording medium is ejected.

According to a nineteenth aspect of the present invention, there is provided with a display controlling method of an image pickup apparatus that images an object and that comprises a displaying unit adapted to display a video of the imaged object or solid white, the display controlling method comprising the steps of detecting the remain capacity of a recording medium disposed in the image pickup apparatus and adapted to record the picked-up image; selecting a video light mode of using the display unit as a video light; and controlling the display by changing over the display unit so as to display the solid white if the video light mode is selected, and by releasing the video light mode to terminate displaying of the solid white by the display unit if the remain capacity of the recording medium drops below a threshold value in the remain capacity detecting step.

According to a twentieth aspect of the present invention, there is provided with a display controlling method of an image pickup apparatus that images an object, comprising a displaying unit adapted to display a video of the imaged object or solid white, the display controlling method comprising the steps of: selecting a video light mode of using the display unit as a video light; controlling the display by changing over the display unit so as to display the solid white if the video light mode is selected; and superposing contents indicating a video light mode releasing method on the display of the changed over solid white; wherein the display controlling step comprises releasing the video light mode to terminate displaying of the solid white by the display unit if a predetermined operation is performed in accordance with the superposed contents indicating a video light mode releasing method.

According to a twenty-first aspect of the present invention, there is provided with an image pickup apparatus that images an object, comprising: a display unit adapted to display a video of the imaged object or solid white; a rec-review reproduction unit adapted to reproduce the picked-up image; a selection unit adapted to select a video light mode of using the display unit as a video light; and a display controlling unit adapted to change over the display unit so as to display the solid white if the video light mode is selected, and release the video light mode to terminate displaying of the solid white by the display unit if the rec-review reproduction unit starts the rec-review, followed by returning to the video light mode to resume displaying of the solid white by the display unit if the rec-review reproduction unit terminates the reproduction of the image.

According to a twenty-second aspect of the present invention, there is provided with a display controlling method of an image pickup apparatus that images an object and that comprises a displaying unit adapted to display a video of the imaged object or solid white, the display controlling method comprising the steps of: rec-review-reproducing the picked-up image; selecting a video light mode of using the display unit as a video light; and controlling the display by changing over the display unit so as to display the solid white if the video light mode is selected, and by releasing the video light mode to terminate displaying of the solid white by the display unit if the rec-review reproduction unit starts the rec-review, followed by returning to the video light mode to resume displaying of the solid white by the display unit if the rec-review reproduction unit terminates reproduction of the image.

According to the first aspect of the present invention, the second display unit turns on in the video light mode to enable confirming and operating a video displayed on the second display unit. For example, even if the display of the first display unit is changed over to the solid white with the first display directed to a shooter, the shooter can confirm the picked-up image through the second display unit and operate the apparatus. This improves operability in the video light mode.

According to the third aspect of the present invention, if the display unit is not in a reversed state in the video light mode, i.e., the display unit is not directed to an object, the luminance of the display unit is reduced to decrease power consumption thereof.

According to the fourth aspect of the present invention, if the display unit is in a normal state where the display unit is directed to the shooter in the video light mode, the luminance of the display unit is reduced to decrease power consumption thereof. In addition, in the normal state where the display unit is directed to the shooter, the luminance of the display unit is reduced to enable reducing dazzlement which the shooter may feel when the mode is changed over to the video light mode.

According to the fifth aspect of the present invention, if the display unit is in a reversed and closed state in the video light mode, the power consumption thereof can be reduced. According to a preferable variation of the fifth aspect, it is enabled to accurately detect the state of the display unit. According to another preferable variation of the fifth aspect, it is applicable to a liquid crystal panel generally used as a display apparatus.

According to the ninth aspect of the present invention, if the display unit displays the solid white in the video light mode and a specific condition occurs, the video light mode is released to terminate the display of the solid white. This enables the user to easily understand the method of releasing the video light mode, improving user friendliness.

According to the tenth aspect of the present invention, if the display unit displays the solid white in the video light mode, merely rendering the display unit to a closing state releases the video light mode to terminate the display of the solid white. This enables the user to easily understand the method of releasing the video light mode which can be performed by a simple operation. Thus, there can be provided the convenient method of releasing the video light mode.

According to the eleventh aspect of the present invention, if a certain time elapses in the video light mode without any key operation, the video light mode is released to terminate the display of the solid white. This reduces the possibility of misunderstanding of the user that a transition to the video light mode by the user's inadvertent operation is caused by a failure.

According to the twelfth aspect of the present invention, an ejecting operation for ejecting a recording medium to the outside when display unit displays the solid white in the video light mode releases the video light mode to terminate the display of the solid white. This eliminates the need for releasing the video light mode when a recording medium is replaced, improving user friendliness.

According to the thirteenth aspect of the present invention, if the capacity of the recording media runs short when display unit displays the solid white in the video light mode, the video light mode is released to terminate the display of the solid white. Thereby, the user can easily understand the recording medium running short through the release of the video light mode, improving user friendliness.

According to the fourteenth aspect of the present invention, contents indicating the method of releasing the video light mode are superposed on the display of the solid white when display unit displays the solid white in the video light mode. Thereby, the user can easily understand the method of releasing the video light mode in any situation.

According to the twenty-first aspect of the present invention, display by the display unit in the video light mode where the display unit displays the solid white can be easily changed over to the reproduction of the picked-up image, making it easy to confirm the picked-up image.

Further features and advantages of the present invention will become apparent from the following detailed description of exemplary embodiments with reference to the attached drawings.

### BRIEF DESCRIPTION OF THE DRAWINGS

FIG. 1 is a schematic perspective view illustrating a configuration of a video camera according to a first embodiment of the present invention.

FIG. 2 is a block diagram illustrating a configuration of a control circuit adapted to execute the control of the liquid crystal monitor 4 in FIG. 1.

FIG. 3 is a flowchart illustrating the operational step in the video light mode in which the liquid crystal panel 5 is used as a video light.

FIG. 4 is a chart illustrating one example of a video-light mode setting screen.

FIG. 5 is a flowchart illustrating the operational step in the video light mode according to a second embodiment of the present invention.

FIG. 6 is a chart illustrating a display screen of the color viewfinder 6.

FIG. 7 is a flowchart illustrating the operational step in the video light mode according to a third embodiment of the present invention.

FIG. 8 is a chart illustrating the video-light mode setting screen and display of the releasing method by the operation key 9.

FIG. 9 is a flowchart illustrating the operational step in the video light mode according to a fourth embodiment of the present invention.

FIG. 10 is a flowchart illustrating the operational step in the video light mode according to a fifth embodiment of the present invention.

FIG. 11 is a block diagram illustrating a configuration of a control circuit adapted to execute the control of an LCD panel in a video camera according to a sixth embodiment of the present invention.

FIG. 12 is a flowchart illustrating the operational step of the video camera.

FIG. 13 is a flowchart illustrating the operational step of the video camera according to a seventh embodiment of the present invention.

FIG. 14 is a block diagram illustrating a configuration of a control circuit in an eighth embodiment of the present invention.

FIG. 15 is a flowchart illustrating the operational step of the video camera.

FIG. 16 is a block diagram illustrating a configuration of a control circuit in a ninth embodiment of the present invention.

FIG. 17 is a flowchart illustrating the operational step of the video camera.

FIG. 18 is a block diagram illustrating a configuration of a control circuit in a tenth embodiment of the present invention.

FIG. 19 is a flowchart illustrating the operational step of the video camera.

FIG. 20 is a block diagram illustrating a configuration of a control circuit in an eleventh embodiment of the present invention.

FIG. 21 is a chart illustrating one example of a screen of the LCD panel 112 on which the method of releasing the video light mode is displayed.

FIG. 22 is a chart illustrating another example of the screen of the LCD panel 112 displaying the method of releasing the video light mode.

FIG. 23 is a block diagram illustrating a configuration of a control circuit in a twelfth embodiment of the present invention.

FIG. 24 is a flowchart illustrating the operational step of the video camera.

FIG. 25 is a perspective view illustrating the external appearance of a video camera as a conventional image pickup apparatus.

FIG. 26 is a block diagram illustrating a configuration of a control circuit implementing the control of the liquid crystal monitor in FIG. 25.

### DETAILED DESCRIPTION OF THE PREFERRED EMBODIMENTS

Embodiments of an image pickup apparatus and a display controlling method therefor of the present invention are described below with reference to the drawings. Each image pickup apparatus according to the embodiments is applied to a video camera.

### First Embodiment

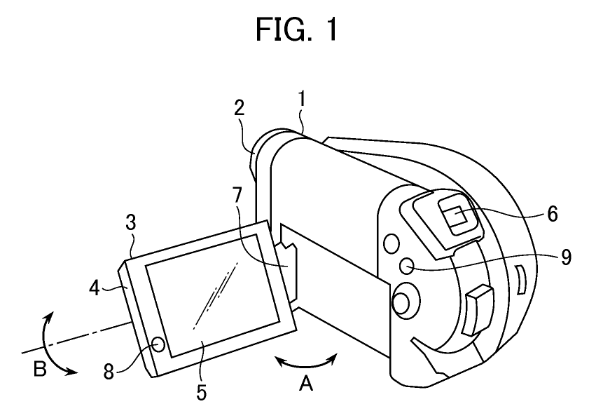

FIG. 1 is a schematic perspective view illustrating a configuration of a video camera according to a first embodiment of the present invention. A video camera is provided with a lens 2 at the front portion of a camera main body 1, a color viewfinder 6 at the rear portion thereof and a liquid crystal monitor 4 at the side portion thereof.

The liquid crystal monitor 4 is a backlight liquid-crystal-display device with a liquid crystal panel 5 capable of displaying a reproduced and a picked-up image and a liquid crystal backlight 3 provided at the rear portion of the liquid crystal panel 5. The liquid crystal monitor 4 is attached to the camera main body 1 with a hinge portion 7, can be opened or closed in the arrow direction A in the figure and is rotatable in the arrow direction B in the figure. For this reason, the liquid crystal panel 5 can be reversed to the side of an object or the side of a shooter. In general, the liquid crystal monitor 4 is solidly whitened (i.e., a state where a transmission factor is maximum) to maximize the quantity of light emitted from the liquid crystal monitor 4, which provides the same state where a video light is projected at the object. By using the phenomenon, the liquid crystal panel 5 can be caused to function as a video light. The liquid crystal monitor 4 (the liquid crystal panel 5) corresponds to a first display unit and the color viewfinder 6 corresponds to a second display unit. A switch adapted to detect the opening and closing of the liquid crystal monitor 4 is provided inside the hinge portion 7.

A cross operation key 8 is provided on the liquid crystal monitor 4. The cross operation key 8 can be operated upward, downward, leftward and rightward and is used when a menu is operated on the display screen to set the video camera. An operation key 9 is a changeover switch adapted to change over the setting of the video camera to ON/OFF.

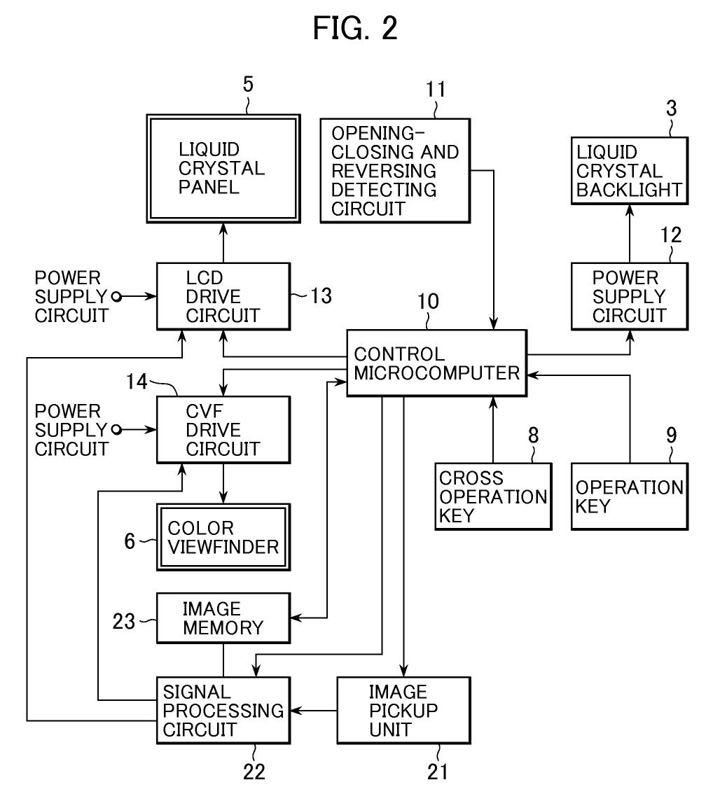

FIG. 2 is a block diagram illustrating a configuration of a control circuit adapted to execute the control of the liquid crystal monitor 4 in FIG. 1. This control circuit is provided inside the camera main body 1. The control circuit includes an LCD drive circuit 13 adapted to drive the liquid crystal panel 5, a CVF drive circuit 14 adapted to drive the color viewfinder 6 and a control microcomputer 10 adapted to control the video camera. The control circuit further includes an opening-closing and reversing detecting circuit 11 adapted to detect whether the liquid crystal monitor 4 is opened, closed or reversed by the switch provided inside the hinge portion 7, the cross operation key 8 adapted to be used for operating the menu screen, the operation key 9 adapted to change over setting to ON/OFF and the power supply circuit 12. The power supply circuit 12 supplies power to the liquid crystal backlight 3. The control circuit still further includes an image pickup unit 21 which has an image pickup element, a CDS circuit and an A/D converter (not shown) and is adapted to output picked-up image data, a signal processing circuit 22 adapted to subject the picked-up image data to required signal processing and an image memory 23 adapted to store the image data subjected to the signal processing.

The control microcomputer 10 controls the LCD drive circuit 13 and the CVF drive circuit 14 based on information inputted from the opening-closing and reversing detecting circuit 11 to turn on and off the liquid crystal panel 5 and the color viewfinder 6 and change over a display image. The control microcomputer 10 controls the LCD drive circuit 13 in accordance with information inputted through the cross operation key 8 and the operation key 9 to change over the display of the liquid crystal panel 5 to the solid white or video display.

The power supply circuit 12 is controlled by the control microcomputer 10 to vary current to be supplied to the liquid crystal backlight 3, adjusting the luminance of the liquid crystal backlight 3.

The operation of the image pickup apparatus configured as stated above is described below. The video camera causes an image pickup element (CCD) (not shown) in the image pickup unit 21 to convert an optical signal of an object incident through the lens 2 into an electric signal to provide a video signal. The video signal is subjected to various signal processings in the signal processing circuit 22 and displayed on the liquid crystal panel 5 and the color viewfinder 6. The shooter depressing a video recording button records the video and audio signals in a recording medium loaded in the camera main body 1.

As described above, the camera main body 1 is provided with the liquid crystal panel 5 and the color viewfinder 6 adapted to display an image which is being picked up and reproduced. The liquid crystal monitor 4 can be opened or closed in the arrow direction A in FIG. 1 and is rotatable in the arrow direction B with a hinge portion 7.

In a normal state where the liquid crystal panel 5 is directed to the shooter, the liquid crystal panel 5 is turned on and the color viewfinder 6 is turned off. For this reason, the shooter picks up an image while viewing the image on the liquid crystal panel 5.

In a storing state where the liquid crystal panel 5 is stored with the liquid crystal panel 5 directed to the camera main body 1, on the other hand, the liquid crystal panel 5 is turned off and the color viewfinder 6 is turned on. For this reason, the shooter picks up an image while viewing the image on the color viewfinder 6.

In an opposing state where the liquid crystal panel 5 is directed to an object, i.e., the liquid crystal panel 5 is directed to the same direction as the lens 2, both the liquid crystal panel 5 and the color viewfinder 6 are turned on. In a state where the liquid crystal panel 5 is not used as a video light, the liquid crystal panel 5 displays a video based on a video signal even in the normal state and in the opposing state.

Two luminance modes such as a normal luminance mode and a high luminance mode in which the luminance is higher than the normal luminance can be set to the liquid crystal backlight 3 of the liquid crystal panel 5. The high luminance mode is used mainly outdoors to improve visibility. A user may select and set any of the normal luminance mode or the high luminance mode by menu operation.

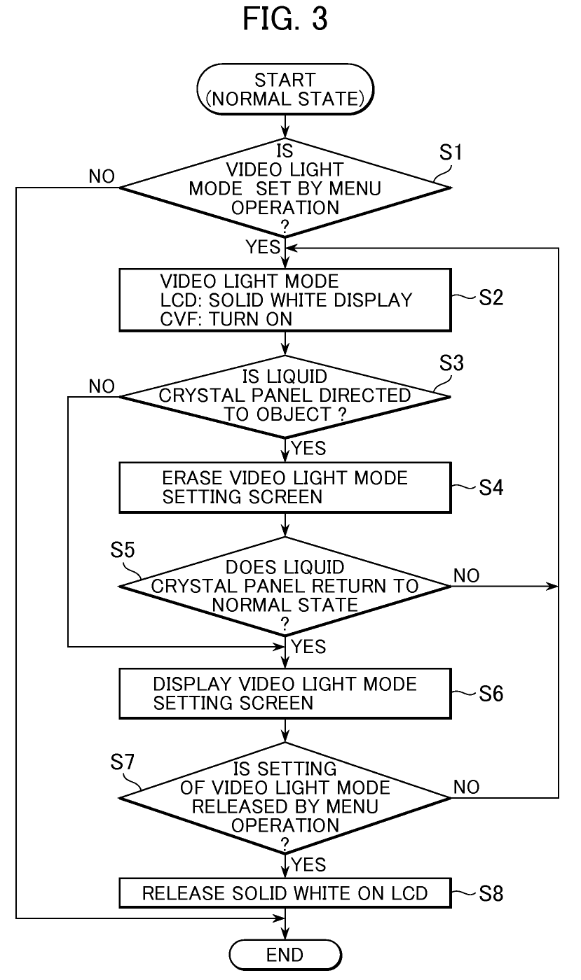

FIG. 3 is a flowchart illustrating the operational step in the video light mode in which the liquid crystal panel 5 is used as a video light. The operation program is stored in a ROM (not shown) in the control microcomputer 10 and executed by a CPU in the control microcomputer 10.

The shooter turns on the power supply of the camera main body 1 and picks up an image in the photographing mode of the normal state in which the liquid crystal panel 5 is directed to the shooter. In the photographing mode, a video based on the video signal in which an optical signal incident through the lens 2 is converted into an electric signal is displayed on the liquid crystal panel 5.

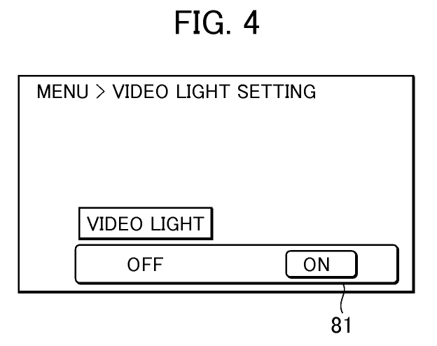

In the display state, the control microcomputer 10 determines whether the shooter operates the cross operation key 8 on the menu screen to set the video light mode (step S1). FIG. 4 is a chart illustrating one example of a video-light mode setting screen. The menu screen is superposed on a video by an on-screen display (OSD) display and displayed. The process in which the menu screen is superposed on a video by the OSD display corresponds to a superposing unit. The video-light mode setting screen is developed from the menu screen. When the shooter sets the mode to the video light mode, the shooter operates the cross operation key 8 rightward to move a cursor 81 to select“ON” on the video-light mode setting screen. If the video light mode is not set, the control microcomputer 10 terminates the present process as it is.

If the video light mode is set, the control microcomputer 10 controls the LCD drive circuit 13 based on the video-light mode ON signal from the cross operation key 8 to change over the display of the liquid crystal panel 5 to the solid white (step S2). At this point, the control microcomputer 10 controls the CVF drive circuit 14 to forcibly turn on the color viewfinder 6. Thus, the control microcomputer 10 forcibly turns on the color viewfinder 6 in the video light mode irrespective of the detection result of the opening-closing and reversing detecting circuit 11. The video-light mode setting screen in FIG. 4 is displayed on the color viewfinder 6 which is turned on. The shooter (user) performs a menu operation while viewing the color viewfinder 6 in the video light mode.

The user rotates the liquid crystal monitor 4 to the side of an object, as indicated in the arrow B (refer to FIG. 1), that is to say, the liquid crystal monitor 4 is directed to the same direction as the lens 2, thereby enabling the liquid crystal panel 5 to be used as a video light adapted to illuminate the object. The control microcomputer 10 determines whether the liquid crystal panel 5 is directed to a reversed state where the liquid crystal panel 5 is directed to the object, based on reversion information from the opening-closing and reversing detecting circuit 11 (step S3). If the liquid crystal panel 5 is not rendered to the reversed state, the control microcomputer 10 proceeds to the process of step S6. If the liquid crystal panel 5 is rendered to the reversed state, on the other hand, the control microcomputer 10 erases a menu screen display (or, a video-light mode setting screen display) on the color viewfinder 6 in accordance with reversion information from the opening-closing and reversing detecting circuit 11 (step S4). Thus, the erasure of the menu screen display makes it easy for the user to view a video displayed on the color viewfinder 6.

The control microcomputer 10 determines whether the liquid crystal panel 5 is returned to the normal state, based on normal-state information from the opening-closing and reversing detecting circuit 11 (step S5). If the liquid crystal panel 5 maintains the reversed state, the control microcomputer 10 repeats the process of step S2. If the shooter rotates the liquid crystal panel 5 to return it to the normal state, the control microcomputer 10 causes the color viewfinder 6 to display the video-light mode setting screen (refer to FIG. 4) thereon (step S6). Even if the liquid crystal panel 5 is not rendered to the reversed state at step S3, the video-light mode setting screen continues to be displayed at step S6. Incidentally, the process in which the video-light mode setting screen is superposed on a video displayed on the color viewfinder corresponds to a superposing unit.

The control microcomputer 10 determines whether the setting of the video light mode is released by the operation of the cross operation key 8 (step S7). When the video light mode is released, the shooter operates the cross operation key 8 leftward to move the cursor 81 to select “OFF” on the video-light mode setting screen. If the setting of the video light mode is not released, that is, if a state where “ON” is selected is kept, the control microcomputer 10 returns to step S2 to execute the same process. If the setting of the video light mode is released, in other words, if the shooter operates the cross operation key 8 leftward to select “OFF,” the control microcomputer 10 releases the video light mode (step S8). That is to say, the control microcomputer 10 controls the LCD drive circuit 13 based on the video-light mode OFF signal from the cross operation key 8 to cause the liquid crystal panel 5 to terminate the solid-white display and display a video signal thereon. Furthermore, the control microcomputer 10 controls the CVF drive circuit 14 to turn off the color viewfinder 6 (returns to the normal state at the time of the normal photographing). After that, the control microcomputer 10 terminates the present process.

According to the image pickup apparatus of the first embodiment, the menu can be operated on the color viewfinder even in the video light mode. Specifically, even in a state where the liquid crystal monitor is directed to the shooter, and when the liquid crystal panel is changed over to the solid white (video light), the shooter can confirm a picked-up image or operate the menu through the color viewfinder. This improves operability in the video light mode. The rotation of the liquid crystal panel allows the OSD display to be automatically erased.

### Second Embodiment

The external appearance and configuration of a video camera according to a second embodiment of the present invention are the same as those according to the first embodiment. The same composing elements as those described in the first embodiment are denoted with the same reference numerals and characters, and the descriptions will be omitted.

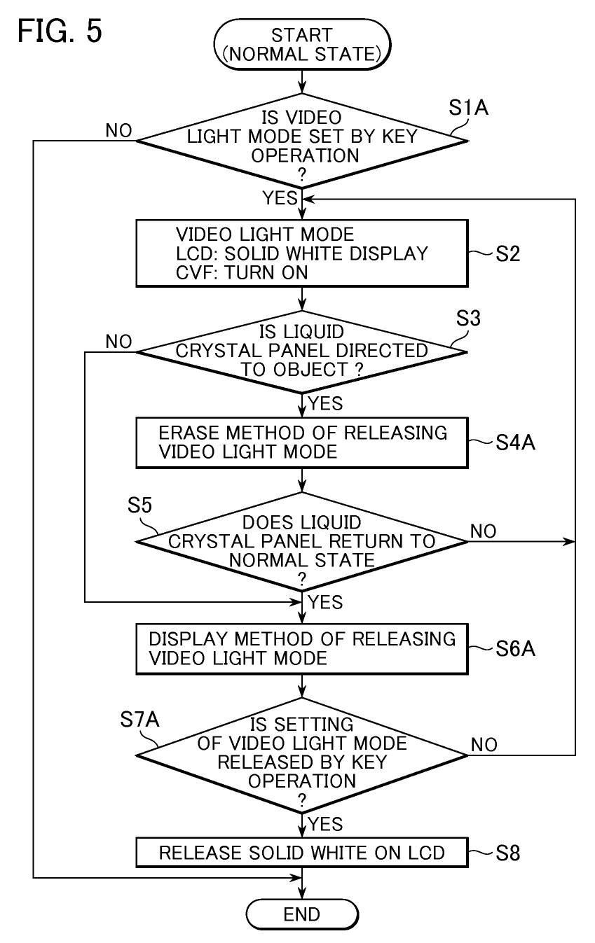

FIG. 5 is a flowchart illustrating the operational step in the video light mode according to a second embodiment of the present invention. The operation program is stored in a ROM (not shown) in the control microcomputer 10 and executed by a CPU in the control microcomputer 10. The same processes at steps as those in the first embodiment are denoted with the same step number.

The shooter turns on the power supply of the camera main body 1 and picks up an image in the photographing mode of the normal state in which the liquid crystal panel 5 is directed to the shooter. In the photographing mode, a video based on the video signal in which an optical signal incident through the lens 2 is converted into an electric signal is displayed on the liquid crystal panel 5.

In the second embodiment, the operation key 9 is allocated to ON/OFF for the video light mode setting. The name of the key is referred to as “Func key.” The operation key 9 repeats the changeover of ON/OFF each time it is depressed. The operation key 9 is set to OFF when the power supply is turned on.

In the display state, the control microcomputer 10 determines whether the video light mode is set by the operation of the operation key 9 (step S1A). If the video light mode is not set, the control microcomputer 10 terminates the process as it is.

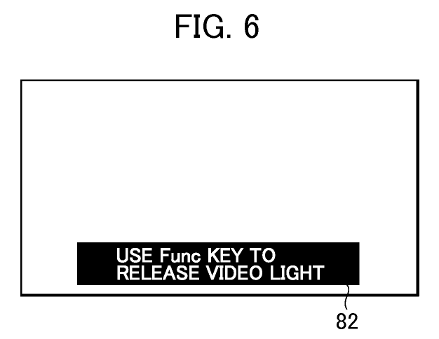

If the video light mode is set, the control microcomputer 10 controls the LCD drive circuit 13 based on the video-light mode ON signal from the operation key 9 to change over the display of the liquid crystal panel 5 to the solid white (step S2). At this point, the control microcomputer 10 controls the CVF drive circuit 14 to forcibly turn on the color viewfinder 6. A method of releasing the video light mode illustrated in FIG. 6 is displayed on the color viewfinder 6 which is turned on. FIG. 6 is a chart illustrating a display screen of the color viewfinder 6. The color viewfinder 6 displays a message image 82 reading “Use func key to release video light” as a method of releasing the video light mode.

The user rotates the liquid crystal panel 5 to the side of an object, as indicated in the arrow B in FIG. 1, that is to say, the liquid crystal panel 5 is directed to the same direction as the lens 2, thereby enabling the liquid crystal panel 5 to be used as a video light.

The control microcomputer 10 determines whether the liquid crystal panel 5 is rendered to a reversed state, based on reversion information from the opening-closing and reversing detecting circuit 11 (step S3). If the liquid crystal panel 5 is not rendered to the reversed state, the control microcomputer 10 proceeds to the process of step S6A. If the liquid crystal panel 5 is rendered to the reversed state, on the other hand, the control microcomputer 10 erases the OSD display of the method of releasing the video light mode on the color viewfinder 6 in accordance with reversion information from the opening-closing and reversing detecting circuit 11 (step S4A). Thus, the erasure of the OSD display of the method of releasing the video light mode makes it easy for the user to view the video displayed on the color viewfinder 6.

The control microcomputer 10 determines whether the liquid crystal panel 5 is returned to the normal state, based on normal-state information from the opening-closing and reversing detecting circuit 11 (step S5). If the liquid crystal panel 5 maintains the reversed state, the control microcomputer 10 repeats the process of step S2. If the shooter rotates the liquid crystal monitor 4 to return it to the normal state, the control microcomputer 10 causes the color viewfinder 6 to display the method of releasing the video light mode (refer to FIG. 6) thereon (step S6A). Even if the liquid crystal panel 5 is not rendered to the reversed state at step S3, the method of releasing the video light mode continues to be displayed at step S6A.

The control microcomputer 10 determines whether the setting of the video light mode is released by depressing the operation key 9 (step S7A). When the video light mode is released, the shooter depresses the operation key 9 to set the video light mode to OFF. If the video light mode is not released, the control microcomputer 10 returns to step S2 to execute the same process. If the video light mode is released by depressing the operation key 9, on the other hand, the control microcomputer 10 controls the LCD drive circuit 13 based on the video-light mode OFF signal from the operation key 9 to cause the liquid crystal panel 5 to terminate the solid-white display and display a video based on a video signal thereon (step S8). Furthermore, the control microcomputer 10 controls the CVF drive circuit 14 to turn off the color viewfinder 6 (returns to the normal state at the time of the normal photographing). After that, the control microcomputer 10 terminates the present process.

Thus, according to the second embodiment, the method of releasing the video light mode can be displayed on the color viewfinder even in the solid-white state of the liquid crystal panel in the video light mode. Thereby, even if the shooter (user) inadvertently sets the mode to the video light mode, the shooter can release the video light mode without confusion.

### Third Embodiment

The external appearance and configuration of a video camera according to a third embodiment of the present invention are the same as those according to the first embodiment. The same composing elements as those described in the first embodiment are denoted with the same reference numerals and characters, and the descriptions will be omitted.

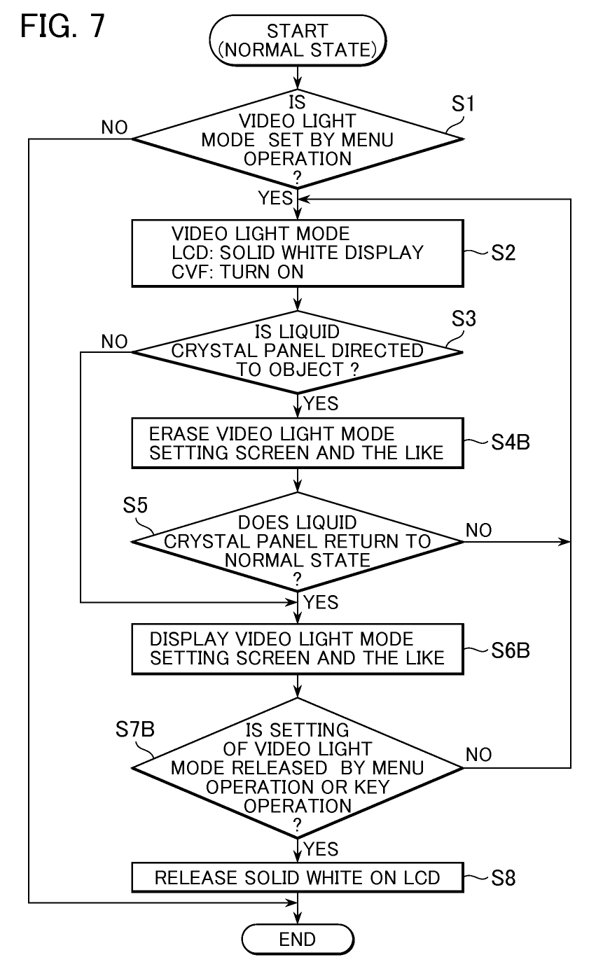

FIG. 7 is a flowchart illustrating the operational step in the video light mode according to the third embodiment. The operation program is stored in a ROM (not shown) in the control microcomputer 10 and executed by a CPU in the control microcomputer 10. The same processes at steps as those in the first and the second embodiment are denoted with the same step number.

The shooter turns on the power supply of the camera main body 1 and picks up an image in the photographing mode of the normal state in which the liquid crystal panel 5 is directed to the shooter. In the photographing mode, a video based on the video signal in which an optical signal incident through the lens 2 is converted into an electric signal is displayed on the liquid crystal panel 5.

In the third embodiment, the operation key 9 is allocated to video-light OFF in the video light mode. The name of the key is referred to as “Func key.”

In the display state, the control microcomputer 10 determines whether the menu screen is operated by the cross operation key 8 to set the video light mode (step S1). The menu screen is superposed on a video signal by the OSD display and displayed. The video-light mode setting screen (refer to FIG. 4) is developed from the menu screen. When the shooter sets the mode to the video light mode, the shooter operates the cross operation key 8 rightward to move a cursor 81 to select “ON.” If the video light mode is not set, the control microcomputer 10 terminates the present process as it is.

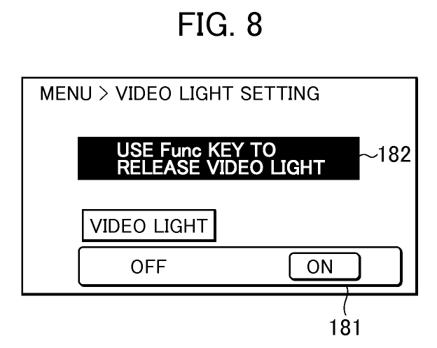

If the video light mode is set, the control microcomputer 10 controls the LCD drive circuit 13 based on the video-light mode ON signal from the cross operation key 8 to change over the display of the liquid crystal panel 5 to the solid white (step S2). At this point, the control microcomputer 10 controls the CVF drive circuit 14 to forcibly turn on the color viewfinder 6. That is, the control microcomputer 10 forcibly turns on the color viewfinder 6 in the video light mode irrespective of the detection result of the opening-closing and reversing detecting circuit 11. As illustrated in FIG. 8, the video-light mode setting screen and the releasing method by the operation key 9 are displayed on the color viewfinder 6 which is turned on. FIG. 8 is a chart illustrating the video-light mode setting screen and display of the releasing method by the operation key 9. The color viewfinder 6 displays a message image 182 reading “Use func key to release video light mode” as a method of releasing the video light mode as well as the video-light mode setting screen. The shooter (user) performs a menu operation while viewing the color viewfinder 6 in the video light mode.

The shooter (user) rotates the liquid crystal panel 5 to the side of an object, as indicated in the arrow B (refer to FIG. 1), that is to say, the liquid crystal panel 5 is directed to the same direction as the lens 2, thereby enabling the liquid crystal panel 5 to be used as a video light. The control microcomputer 10 determines whether the liquid crystal panel 5 is rendered to a reversed state, based on reversion information from the opening-closing and reversing detecting circuit 11 (step S3). If the liquid crystal panel 5 is not rendered to the reversed state, the control microcomputer 10 proceeds to the process of step S6B. If the liquid crystal panel 5 is rendered to the reversed state, on the other hand, the control microcomputer 10 erases a menu screen display (or, a video-light mode setting screen display and display of the releasing method by the operation key 9) on the color viewfinder 6 in accordance with reversion information from the opening-closing and reversing detecting circuit 11 (step S4B). Thus, the erasure of the menu screen display makes it easy for the user to view a video displayed on the color viewfinder 6.

The control microcomputer 10 determines whether the liquid crystal panel 5 is returned to the normal state, based on normal-state information from the opening-closing and reversing detecting circuit 11 (step S5). If the liquid crystal panel 5 maintains the reversed state, the control microcomputer 10 repeats the process of step S2. If the shooter rotates the liquid crystal panel 5 to return it to the normal state, the control microcomputer 10 causes the color viewfinder 6 to display the video-light mode setting screen and the releasing method by the operation key 9 (refer to FIG. 8) thereon (step S6B).

When the video light mode is released, the shooter operates the cross operation key 8 leftward to move the cursor 181 to select “OFF” on the video-light mode setting screen. Alternately, the shooter depresses the operation key 9 to set the video-light mode to OFF.

The control microcomputer 10 determines whether the setting of the video light mode is released by the operation of the cross operation key 8 or the depression of the operation key 9 (step S7B). If the setting of the video light mode is not released, the control microcomputer 10 returns to step S2 to execute the same process. If the setting of the video light mode is released, the control microcomputer 10 controls the LCD drive circuit 13 based on the video-light mode OFF signal from the cross operation key 8 or the operation key 9 to cause the liquid crystal panel 5 to terminate the solid-white display and display a video signal thereon (step S8). Furthermore, the control microcomputer 10 controls the CVF drive circuit 14 to turn off the color viewfinder 6 (returns to the normal state at the time of the normal photographing). After that, the control microcomputer 10 terminates the present process.

According to the image pickup apparatus of the third embodiment, the menu can be operated on the color viewfinder even in the video light mode and the video light mode can be released by operating the key. This further improves operability in the video light mode. The rotation of the liquid crystal panel allows the OSD display to be automatically erased.

### Fourth Embodiment

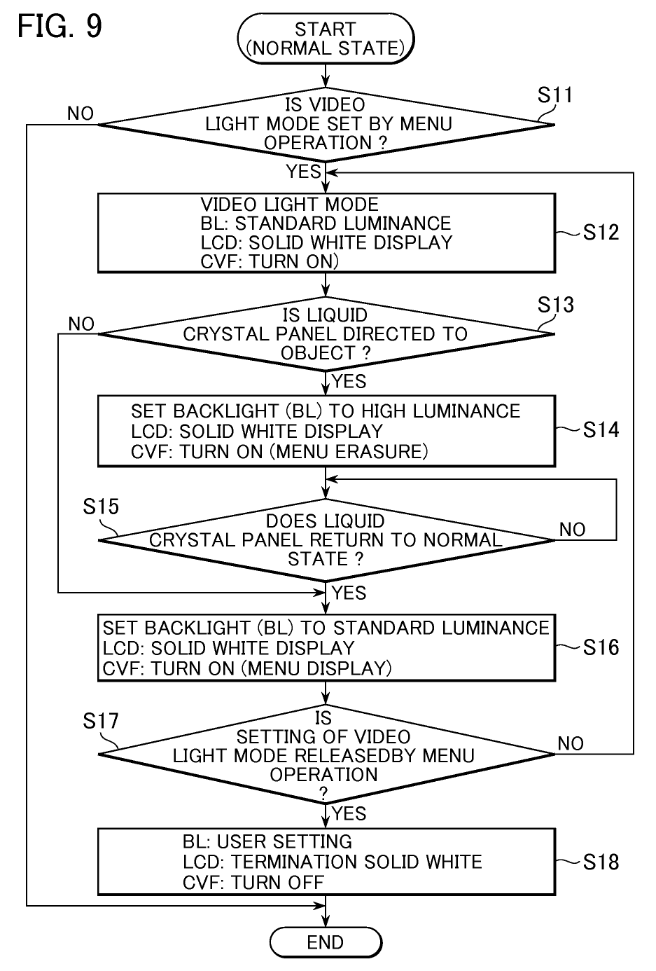

FIG. 9 is a flowchart illustrating the operational step in the video light mode according to the fourth embodiment of the present invention. The operation program is stored in a ROM (not shown) in the control microcomputer 10 and executed by a CPU in the control microcomputer 10. The external appearance and configuration of a video camera of the present embodiment are the same as those described in the first embodiment, and the descriptions thereof will be omitted.

The shooter turns on the power supply of the camera main body 1 and picks up an image in the photographing mode of the normal state in which the liquid crystal panel 5 is directed to the shooter. In the photographing mode, a video based on the video signal in which an optical signal incident through the lens 2 is converted into an electric signal is displayed on the liquid crystal panel 5. In the state, the luminance of the liquid crystal backlight 3 has been rendered to a luminance mode (a user-setting luminance mode) set by the user.

In the display state, the control microcomputer 10 determines whether the shooter operates the cross operation key 8 on the menu screen to set the video light mode (step S1). An image of the menu screen is superposed on a video by the on-screen display (OSD) display and displayed, as is the case with the first embodiment. The video-light mode setting screen is developed from the menu screen. When the shooter sets the mode to the video light mode, the shooter operates the cross operation key 8 rightward to move the cursor 81 to select “ON” on the video-light mode setting screen. If the video light mode is not set, the control microcomputer 10 terminates the present process as it is.

If the video light mode is set, on the other hand, the control microcomputer 10 controls the LCD drive circuit 13 based on the video-light mode ON signal from the cross operation key 8 to change over the display of the liquid crystal panel 5 to the solid white (step S12). At this point, the control microcomputer 10 controls the power supply circuit 12 to forcibly set the luminance of the liquid crystal backlight 3 to a standard luminance mode irrespective of the user-setting luminance mode. The power supply circuit 12 corresponds to a luminance adjusting unit according to the claim. Furthermore, the control microcomputer 10 controls the CVF drive circuit 14 to forcibly turn on the color viewfinder 6. Thus, the control microcomputer 10 forcibly turns on the color viewfinder 6 in the video light mode irrespective of the detection result of the opening-closing and reversing detecting circuit 11. The video-light mode setting screen in FIG. 4 is displayed on the color viewfinder 6 which is turned on.

The user rotates the liquid crystal monitor 4 to the side of an object, as indicated in the arrow B (refer to FIG. 1), that is to say, the liquid crystal monitor 4 is directed to the same direction as the lens 2, thereby enabling the liquid crystal panel 5 to be used as a video light adapted to illuminate the object. The control microcomputer 10 determines whether the liquid crystal panel 5 is rendered to a reversed state where the liquid crystal panel 5 is directed to the object, based on reversion information from the opening-closing and reversing detecting circuit 11 (step S13). If the liquid crystal panel 5 is not rendered to the reversed state, the control microcomputer 10 proceeds to the process of step S16. If the liquid crystal panel 5 is rendered to the reversed state, on the other hand, the control microcomputer 10 controls the power supply circuit 12 to set the luminance of the liquid crystal backlight 3 to the high luminance mode in accordance with reversion information from the opening-closing and reversing detecting circuit 11 (step S14). The process at step S4 executed by the control microcomputer 10 corresponds to a luminance controlling unit according to the claim. The control microcomputer 10 erases a menu screen display (or, a video-light mode setting screen display) on the color viewfinder 6. Thus, the erasure of the menu screen display makes it easy for the user to view a video displayed on the color viewfinder 6.

The control microcomputer 10 determines whether the liquid crystal panel 5 is returned to the normal state, based on normal-state information from the opening-closing and reversing detecting circuit 11 (step S15). If the liquid crystal panel 5 maintains the reversed state, the control microcomputer 10 repeats the process of step S5. If the shooter rotates the liquid crystal panel 5 to return it to the normal state, the control microcomputer 10 controls the power supply circuit 12 to return the luminance of the liquid crystal backlight 3 to the standard luminance mode (step S16). In addition, the control microcomputer 10 causes the color viewfinder 6 to display the video-light mode setting screen (refer to FIG. 4) thereon. Even if the liquid crystal panel 5 is not rendered to the reversed state at step S3, the luminance of the liquid crystal backlight 3 in the standard luminance mode and the display of the video-light mode setting screen continue at step S16.

The control microcomputer 10 determines whether the setting of the video light mode is released by the operation of the cross operation key 8 (step S17). When the video light mode is released, the shooter operates the cross operation key 8 leftward to move the cursor 81 to select “OFF” on the video-light mode setting screen. If the setting of the video light mode is not released, that is, if a state where “ON” is selected is kept, the control microcomputer 10 returns to step S2 to execute the same process. If the setting of the video light mode is released, in other words, if the shooter operates the cross operation key 8 leftward to select “OFF,” the control microcomputer 10 releases the video light mode (step S18). That is to say, the control microcomputer 10 controls the LCD drive circuit 13 based on the video-light mode OFF signal from the cross operation key 8 to cause the liquid crystal panel 5 to terminate the solid-white display and display a video signal thereon. In addition, the control microcomputer 10 controls the power supply circuit 12 to return the luminance of the liquid crystal backlight 3 to the user-setting luminance mode. Furthermore, the control microcomputer 10 controls the CVF drive circuit 14 to turn off the color viewfinder 6. This causes the video camera to return to the normal state at the time of normal photographing. After that, the control microcomputer 10 terminates the present process.

According to the image pickup apparatus of the fourth embodiment, the power consumption thereof can be reduced if the liquid crystal panel is directed to the shooter in the video light mode. In addition, lowering the luminance of the liquid crystal backlight with the liquid crystal panel directed to the shooter enables reducing dazzlement which the user may feel when the mode is changed over to the video light mode.

Although, in the present embodiment, the luminance of the liquid crystal backlight is set to the standard luminance mode when the liquid crystal panel is directed to the shooter in the video light mode, the luminance of the liquid crystal backlight may be lower than that in the high luminance mode, which achieves the same effect.

### Fifth Embodiment

The external appearance and configuration of a video camera according to the fifth embodiment are the same as those according to the first embodiment. The same composing elements as those described in the first embodiment are denoted with the same reference numerals and characters, and the descriptions thereof will be omitted.

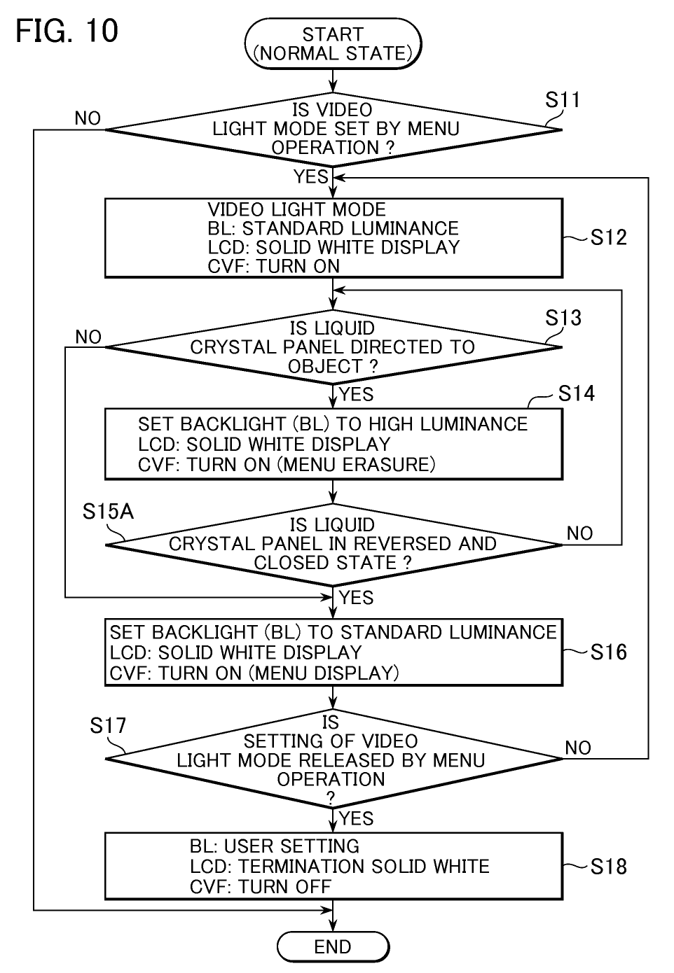

FIG. 10 is a flowchart illustrating the operational step in the video light mode according to the fifth embodiment. The operation program is stored in a ROM (not shown) in the control microcomputer 10 and executed by a CPU in the control microcomputer 10. The same processes at steps as those in the first embodiment are denoted with the same step number.

The shooter turns on the power supply of the camera main body 1 and picks up an image in the photographing mode of the normal state in which the liquid crystal panel 5 is directed to the shooter. In the photographing mode, a video based on the video signal in which an optical signal incident through the lens 2 is converted into an electric signal is displayed on the liquid crystal panel 5. In the state, the luminance of the liquid crystal backlight 3 has been rendered to a luminance mode (a user-setting luminance mode) set by the user.

In the display state, the control microcomputer 10 determines whether the shooter operates the cross operation key 8 on the menu screen to set the video light mode (step S11). An image of the menu screen (refer to FIG. 4) is superposed on a video by the on-screen display (OSD) display and displayed. The video-light mode setting screen is developed from the menu screen. When the shooter sets the mode to the video light mode, the shooter operates the cross operation key 8 rightward to move the cursor 81 to select “ON” on the video-light mode setting screen. If the video light mode is not set, the control microcomputer 10 terminates the present process as it is.

If the video light mode is set, on the other hand, the control microcomputer 10 controls the LCD drive circuit 13 based on the video-light mode ON signal from the cross operation key 8 to change over the display of the liquid crystal panel 5 to the solid white (step S12). In addition, the control microcomputer 10 controls the power supply circuit 12 to forcibly set the luminance of the liquid crystal backlight 3 to a standard luminance mode irrespective of the user-setting luminance mode. Furthermore, the control microcomputer 10 controls the CVF drive circuit 14 to forcibly turn on the color viewfinder 6. Thus, the control microcomputer 10 forcibly turns on the color viewfinder 6 in the video light mode irrespective of the detection result of the opening-closing and reversing detecting circuit 11. The video-light mode setting screen in FIG. 4 is displayed on the color viewfinder 6 which is turned on.

The user rotates the liquid crystal monitor 4 to the side of an object, as indicated in the arrow B (refer to FIG. 1), that is to say, the liquid crystal monitor 4 is directed to the same direction as the lens 2, thereby enabling the liquid crystal panel 5 to be used as a video light adapted to illuminate the object. The control microcomputer 10 determines whether the liquid crystal panel 5 is rendered to a reversed state where the liquid crystal panel 5 is directed to the object, based on reversion information from the opening-closing and reversing detecting circuit 11 (step S13). If the liquid crystal panel 5 is not rendered to the reversed state, the control microcomputer 10 proceeds to the process of step S16. If the liquid crystal panel 5 is rendered to the reversed state, on the other hand, the control microcomputer 10 controls the power supply circuit 12 to set the luminance of the liquid crystal backlight 3 to a high luminance mode in accordance with reversion information from the opening-closing and reversing detecting circuit 11 (step S14). At this point, the control microcomputer 10 erases a menu screen display (or, a video-light mode setting screen display) on the color viewfinder 6. Thus, the erasure of the menu screen display makes it easy for the user to view a video displayed on the color viewfinder 6.

The liquid crystal monitor 4 in the reversed state can be closed onto the camera main body 1 as indicated in the arrow A (refer to FIG. 1) and rendered into a reversed and closed state. The control microcomputer 10 determines whether the liquid crystal panel 5 is rendered into a reversed and closed state, based on reversed and closed information from the opening-closing and reversing detecting circuit 11 (step S15A).

If the liquid crystal panel 5 is not rendered into the reversed and closed state, the control microcomputer 10 returns to the process of step S3. If the shooter closes the liquid crystal panel 5 to render it into the reversed and closed state, on the other hand, the control microcomputer 10 controls the power supply circuit 12 to return the luminance of the liquid crystal backlight 3 to the standard luminance mode (step S16). In addition, the control microcomputer 10 causes the color viewfinder 6 to display the video-light mode setting screen (refer to FIG. 4) thereon. Even if the liquid crystal panel 5 is not rendered to the reversed state at step S3, the luminance of the liquid crystal backlight 3 in the standard luminance mode and the display of the video-light mode setting screen continue at step S16.

The control microcomputer 10 determines whether the setting of the video light mode is released by the operation of the cross operation key 8 (step S17). When the video light mode is released, the shooter operates the cross operation key 8 leftward to move the cursor 81 to select “OFF” on the video-light mode setting screen. If the setting of the video light mode is not released, that is, if a state where “ON” is selected is kept, the control microcomputer 10 returns to step S12 to execute the same process. If the setting of the video light mode is released, in other words, if the shooter operates the cross operation key 8 leftward to select “OFF,” the control microcomputer 10 releases the video light mode (step S18). That is to say, the control microcomputer 10 controls the LCD drive circuit 13 based on the video-light mode OFF signal from the cross operation key 8 to cause the liquid crystal panel 5 to terminate the solid-white display and display a video signal thereon. In addition, the control microcomputer 10 controls the power supply circuit 12 to return the luminance of the liquid crystal backlight 3 to the user-setting luminance mode. Furthermore, the control microcomputer 10 controls the CVF drive circuit 14 to turn off the color viewfinder 6. This causes the video camera to return to the normal state at the time of normal photographing. After that, the control microcomputer 10 terminates the present process.

According to the image pickup apparatus of the fifth embodiment, the power consumption thereof can be reduced if the liquid crystal panel is rendered into the reversed and closed state in the video light mode. Although, in the present embodiment, the luminance of the liquid crystal backlight is set to the standard luminance mode when the liquid crystal panel is rendered into the reversed and closed state in the video light mode, the luminance of the liquid crystal backlight may be lower than that in the high luminance mode, which achieves the same effect.

### Sixth Embodiment

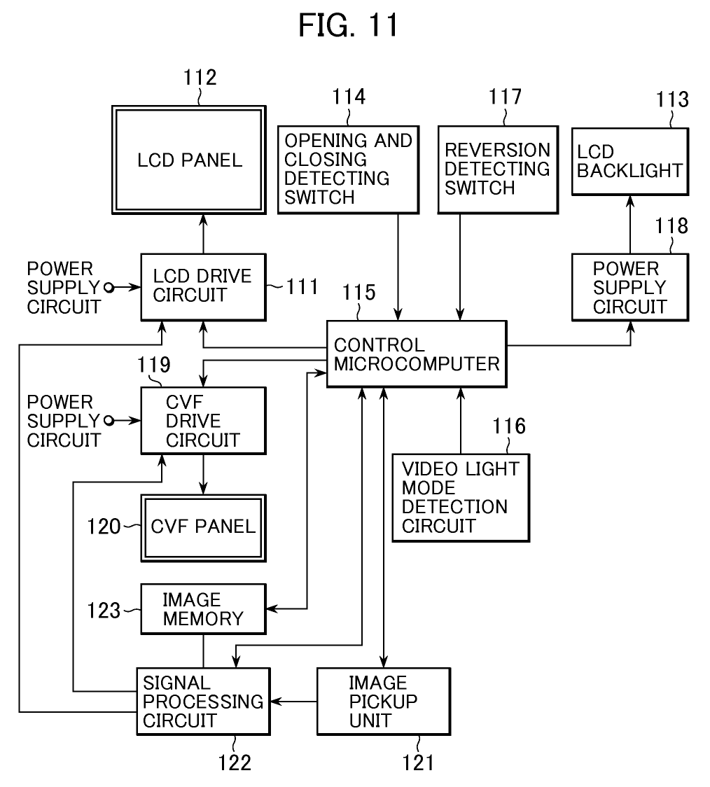

FIG. 11 is a block diagram illustrating a configuration of a control circuit adapted to execute the control of an LCD panel in a video camera according to a sixth embodiment of the present invention. The external appearance of the video camera of the embodiment is the same as that in the first embodiment, and the descriptions thereof will be omitted.

The control circuit is provided in the camera main body 1. The control circuit includes an LCD drive circuit 111 adapted to drive an LCD panel 112, a CVF drive circuit 119 adapted to drive a CVF panel 120 disposed in the color viewfinder 6 and a control microcomputer 115 adapted to control the video camera. The control circuit further includes an opening and closing detecting switch 114 adapted to detect the LCD panel 112 opening or closing in the arrow direction A (an open and close state) and a reversion detecting switch 117 adapted to detect the LCD panel 112 rotating in the arrow direction B. The reversion detecting switch 117 detects whether the LCD panel 112 is directed to the object or the shooter. The control circuit still further includes a video light mode detection circuit 116 adapted to detect ON/OFF of the video light mode and a power supply circuit 118 adapted to supply power to an LCD backlight 113. The control circuit still further includes an image pickup unit 121 which has an image pickup element, a CDS circuit and an A/D converter (not shown) and is adapted to output picked-up image data, a signal processing circuit 122 adapted to subject the picked-up image data to required signal processing and an image memory 123 adapted to store the image data subjected to the signal processing.

The control microcomputer 115 turns ON/OFF the display of a video on the LCD panel 112 and the CVF panel 120 according to the detection result of opening-closing and reversion of the LCD panel 112. The video light mode detection circuit 116 detects ON/OFF of the video light mode set or selected by the shooter operating a predetermined menu or a key. When the ON state of the video light mode is detected, the LCD panel 112 can be solidly whitened. The LCD drive circuit 111 and the CVF drive circuit 119 drive the LCD panel 112 and the CVF panel 120 to cause them to display a separately inputted video signal thereon according to a control signal from the control microcomputer 115.

The operation of the video camera serving as the image pickup apparatus with the above mentioned configuration is described below. The video camera causes an image pickup element (CCD) (not shown) incorporated in the camera main body 1 to convert an optical signal of an object incident through a lens 2 into an electric signal to provide a video signal. The video signal is subjected to various signal processings in the signal processing circuit 122 and displayed on the LCD panel 112. The shooter depressing a video recording button records the video and audio signals in a recording medium such as a video tape loaded therein.

As described above, the camera main body 1 is provided with the LCD panel 112 adapted to display an image which is being picked up and reproduced. The LCD panel 112 can be opened or closed in the arrow direction A in FIG. 1 and is rotatable in the arrow direction B in FIG. 1 with a hinge portion 7. In other words, the LCD panel 112 can be rotatably set to a normal photographing state where the LCD panel 112 is directed to the shooter and to a face-to-face photographing state where the LCD panel 112 is directed to an object, i.e., the LCD panel 112 is directed in the same direction as the lens 2.

When the LCD panel 112 is not used as a video light, a video signal is displayed on the LCD panel 112 both in the normal photographing state and in the face-to-face photographing state. Hereinafter, the state illustrated in FIG. 1 is referred to as a normal state, and a state where the LCD panel 112 is closed onto the camera main body in the arrow direction A in FIG. 1 in the normal state is referred to as a normal storing state. In addition, a state where the LCD panel 112 is rotated in the arrow direction B from the state (normal state) in FIG. 1 to the object side is referred to as an opposing state (reversed state). A state where the LCD panel 112 is closed in the arrow direction A in FIG. 1 in the opposing state is referred to as a reversed and stored state.

The operation of the LCD panel 112 used as a video light is described below. Turning on the power supply of the camera main body 1 causes the LCD panel 112 to display a video signal in which an optical signal incident through the lens 2 is converted into an electric signal when the video camera is in the photographing mode.

When the video light mode detection circuit 116 inputs the video-light mode ON signal to the control microcomputer 115, the control microcomputer 115 sends a control signal to the LCD drive circuit 111 to change over the display of the LCD panel 112 to a solid white to use it as a video light.

The LCD drive circuit 111 stops outputting a video signal to the LCD panel 112 based on the control signal from the control microcomputer 115 and sends a signal adapted to make the display of the LCD panel 112 solid white instead. When the LCD panel 112 is rendered to the opposing state where the LCD panel 112 is directed to the object, the LCD panel 112 can be used as a video light. Thus, the quantity of light from the LCD panel 112 is maximized to illuminate the object, functioning as the video light. The illuminance of the LCD backlight 113 may be increased as required to increase the quantity of light of the LCD panel 112 at the time of solidly whitening the LCD panel 112. More specifically, when the video light mode detection circuit 116 detects the ON signal, the control microcomputer 115 inputs a control signal to the power supply circuit 118 to increase the voltage of the power supply circuit 118, increasing the illuminance of the LCD backlight 113. Incidentally, as the LCD backlight 113, there may be used any type of a direct-backlight fluorescent tube or a fluorescent tube with a light-guide plate.

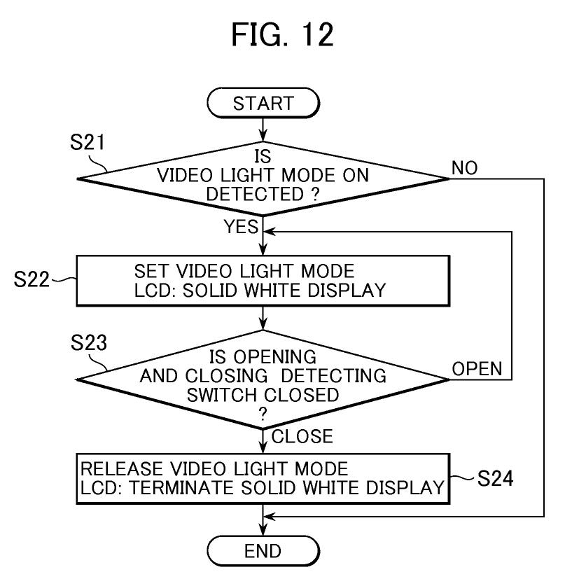

A method of releasing the video light mode is described below. FIG. 12 is a flowchart illustrating the operational step of the video camera. The operation program is stored in a ROM (not shown) in the control microcomputer 115 and executed by a CPU in the control microcomputer 115.

The control microcomputer 115 determines whether the video light mode detection circuit 116 detects that the video light mode is ON (step S21). If the video light mode detection circuit 116 detects that the video light mode is OFF, the control microcomputer 115 terminates the present process as it is.

If the video light mode detection circuit 116 detects that the video light mode is ON, the control microcomputer 115 changes over the display of the LCD panel 112 to the solid white (step S22). The control microcomputer 115 determines whether the closing state of the opening and closing detecting switch 114 is detected in the video light mode where the display of the LCD panel 112 is changed over to the solid white (step S23). If the closing state of the opening and closing detecting switch 114 is detected, it is determined that a specific condition occurs.

If the closing state of the opening and closing detecting switch 114 is detected at step S23, the control microcomputer 115 releases the video light mode and causes the LCD panel 112 to terminate the display of the solid white (step S24). After that the control microcomputer 115 terminates the present process. If the opening and closing detecting switch 114 opens at step S23, the control microcomputer 115 returns to step S22 and holds the display of the solid white on the LCD panel 112.

Thus, according to the image pickup apparatus of the sixth embodiment, merely closing the LCD panel which is displaying the solid white in the video light mode releases the video light mode to terminate the display of the solid white. For this reason, the user can easily understand how to release the video light mode. This improves user friendliness and provides a user-friendly method of releasing the video light mode.

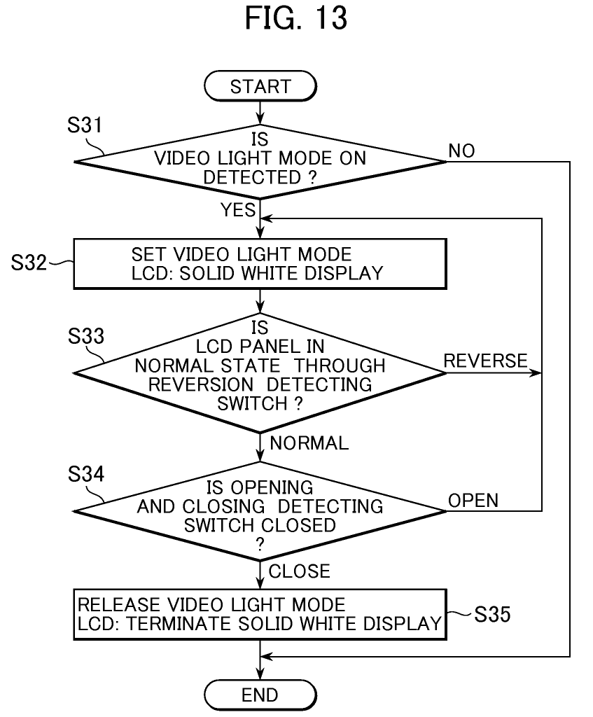

Although, in the above embodiment, the video light mode is released when the LCD panel 112 is closed, the video light mode may be released only in the normal storing state. FIG. 13 is a flowchart illustrating the operational step of the video camera according to a seventh embodiment of the present invention. The operation program is stored in a ROM (not shown) in the control microcomputer 115 and executed by a CPU (not shown) in the control microcomputer 115.

The control microcomputer 115 determines whether the video light mode detection circuit 116 detects that the video light mode is ON (step S31). If the video light mode detection circuit 116 detects that the video light mode is OFF, the control microcomputer 115 terminates the present process as it is.

If the video light mode detection circuit 116 detects that the video light mode is ON, the control microcomputer 115 changes over the display of the LCD panel 112 to the solid white (step S32). The control microcomputer 115 detects through the reversion detecting switch 117 whether the LCD panel 112 is in the normal state in the video light mode where the display of the LCD panel 112 is changed over to the solid white (step S33). If the LCD panel 112 is in the normal state, the control microcomputer 115 determines whether the closing state of the opening and closing detecting switch 114 is detected (step S34).

If the closing state of the opening and closing detecting switch 114 is detected, that is to say, the LCD panel 112 is in the normal storing state, the control microcomputer 115 releases the video light mode and causes the LCD panel 112 to terminate the display of the solid white (step S35). On the other hand, if the reversed state is detected by the reversion detecting switch 117 at step S33 or if the opening and closing detecting switch 114 opens at step S34, the control microcomputer 115 returns to step S32 and holds the display of the solid white of the LCD panel 112. The state corresponds to any of the normal state, the opposing state and the reversed and stored state.

Thus, the video light mode is released as long as the LCD panel 112 is in the normal storing state where the solid white does not need displaying, thereby the user can easily understand how to release the video light mode.

### Eighth Embodiment

A method of releasing the video light mode in the image pickup apparatus of an eighth embodiment of the present invention is described below. The configuration of the image pickup apparatus according to the eighth embodiment is substantially the same as that in the sixth embodiment. The same composing elements as those described in the sixth embodiment are denoted with the same reference numerals and characters to omit further description thereof. The configuration different from that in the sixth embodiment is described herein.

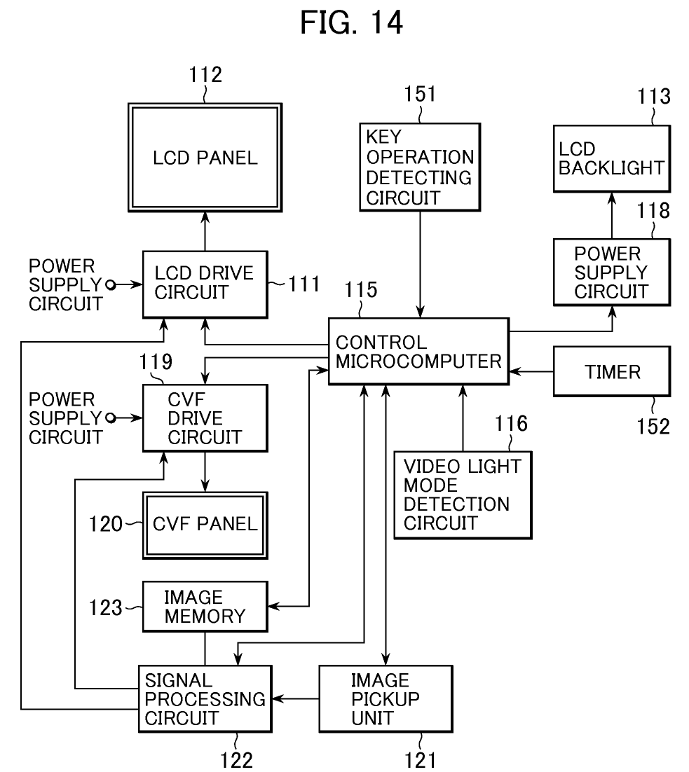

FIG. 14 is a block diagram illustrating a configuration of a control circuit in the eighth embodiment. The control circuit is different from that in the sixth embodiment in that a key operation detecting circuit 151 and a timer 152 are added to the control circuit to enable detecting whether a predetermined key (not shown) provided on the camera main body 1 is operated and measuring the elapsed time since the latest key operation. Incidentally, the opening and closing detecting switch 114 and the reversion detecting switch 117 in the sixth embodiment are omitted.

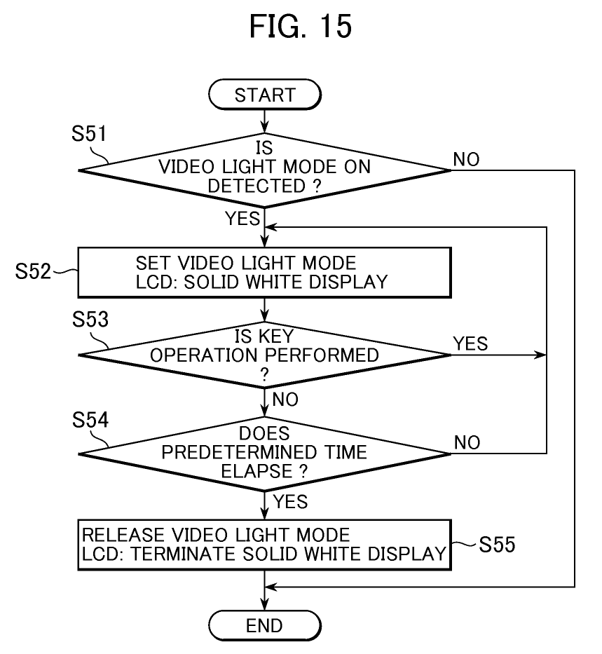

FIG. 15 is a flowchart illustrating the operational step of the video camera. The operation program is stored in a ROM (not shown) in the control microcomputer 115 and executed by a CPU (not shown) in the control microcomputer 115. At the time of starting the operation, the timer is reset to an initial value 0.

The control microcomputer 115 determines whether the video light mode detection circuit 116 detects that the video light mode is ON (step S51). If the video light mode detection circuit 116 detects that the video light mode is OFF, the control microcomputer 115 terminates the present process as it is.

If the video light mode detection circuit 116 detects that the video light mode is ON, the control microcomputer 115 changes over the display of the LCD panel 112 to the solid white (step S52). The control microcomputer 115 determines whether the key operation detecting circuit 151 detects that a key operation is performed in the video light mode where the display of the LCD panel 112 is changed over to the solid white (step S53).

If it is determined through the key operation detecting circuit 151 that the key operation is not performed, the control microcomputer 115 detects whether time which has been measured by the timer 152 since the latest key operation exceeds a predetermined time (step S54). If it is detected that the time measured by the timer 152 has exceeded the predetermined time, the control microcomputer 115 releases the video light mode and causes the LCD panel 112 to terminate the display of the solid white (step 855). After that, the control microcomputer 115 terminates the present process.

If it is determined through the key operation detecting circuit 151 that any key operation is performed at step S53, on the other hand, the control microcomputer 115 returns to step S52 and holds the video light mode to keep the LCD panel 112 solidly white. At this point, the control microcomputer 115 resets the timer 152 to the initial value 0. If the time which has been measured by the timer 152 since the latest key operation does not exceed the predetermined time at step S54, the control microcomputer 115 returns to step S52 and holds the video light mode to keep the LCD panel 112 solidly white.

Thus, according to the eighth embodiment, if a certain time elapses in the video light mode without any key operation, the video light mode is released and the display of the solid white is terminated. This reduces the possibility of misunderstanding of the user that a transition to the video light mode by the user's inadvertent operation is caused by a failure.

### Ninth Embodiment

A method of releasing the video light mode in the image pickup apparatus of the ninth embodiment is described below. The configuration of the image pickup apparatus according to the ninth embodiment is substantially the same as that in the sixth embodiment. The same composing elements as those described in the sixth embodiment are denoted with the same reference numerals and characters to omit further description thereof. The configuration different from that in the sixth embodiment is described herein.

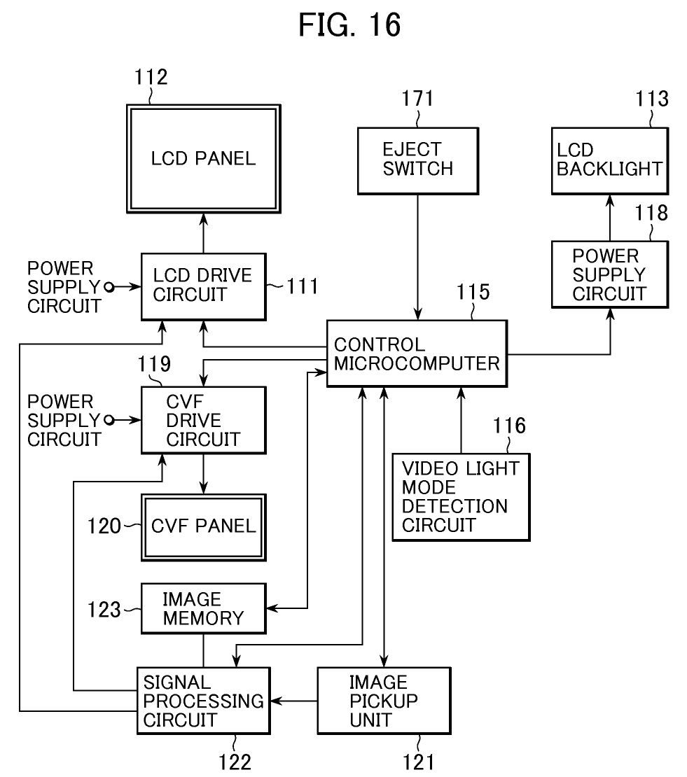

FIG. 16 is a block diagram illustrating a configuration of a control circuit in a ninth embodiment of the present invention. The control circuit is different from that in the sixth embodiment in that an EJECT switch 171 is added to the control circuit to enable ejecting a recording medium from the camera main body 1 to the outside. Incidentally, the opening and closing detecting switch 114 and the reversion detecting switch 117 in the sixth embodiment are omitted.

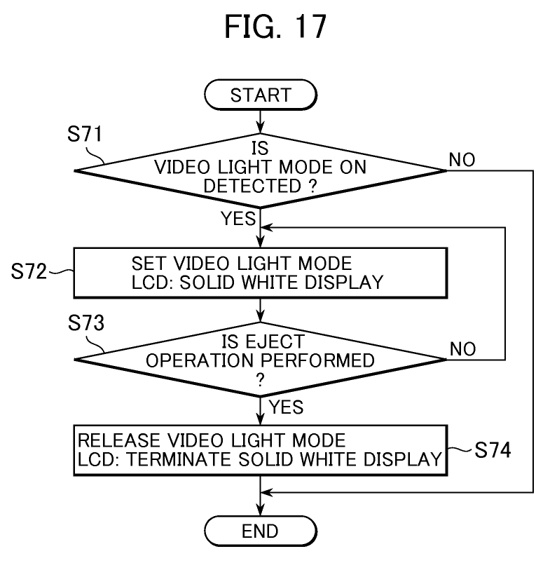

FIG. 17 is a flowchart illustrating the operational step of the video camera. The operation program is stored in a ROM (not shown) in the control microcomputer 115 and executed by a CPU (not shown) in the control microcomputer 115.

The control microcomputer 115 determines whether the video light mode detection circuit 116 detects that the video light mode is ON (step S71). If the video light mode detection circuit 116 detects that the video light mode is OFF, the control microcomputer 115 terminates the present process as it is.

If the video light mode detection circuit 116 detects that the video light mode is ON, the control microcomputer 115 changes over the display of the LCD panel 112 to the solid white (step S72). The control microcomputer 115 determines whether the shooter operates the EJECT switch 171 to perform an EJECT operation for taking a recording medium out of the camera main body to the outside in the video light mode where the display of the LCD panel 112 is changed over to the solid white (step S73). The process at step S73 corresponds to an ejection detecting unit.

If it is determined that the EJECT operation is performed at step S73, the control microcomputer 115 releases the video light mode and causes the LCD panel 112 to terminate the display of the solid white (step S74). After that, the control microcomputer 115 terminates the present process.

If it is determined that the EJECT operation is not performed at step 73, on the other hand, the control microcomputer 115 returns to step S72 and holds the video light mode to keep the LCD panel 112 solidly white. After that, the control microcomputer 115 terminates the present process.

Thus, according to the ninth embodiment, when the recording medium is taken out of the camera main body in the video light mode where the LCD panel displays the solid white, the video light mode is released and the display of the solid white is terminated. This eliminates the need for releasing the video light mode at the time of replacing the recording medium to improve user friendliness.

### Tenth Embodiment

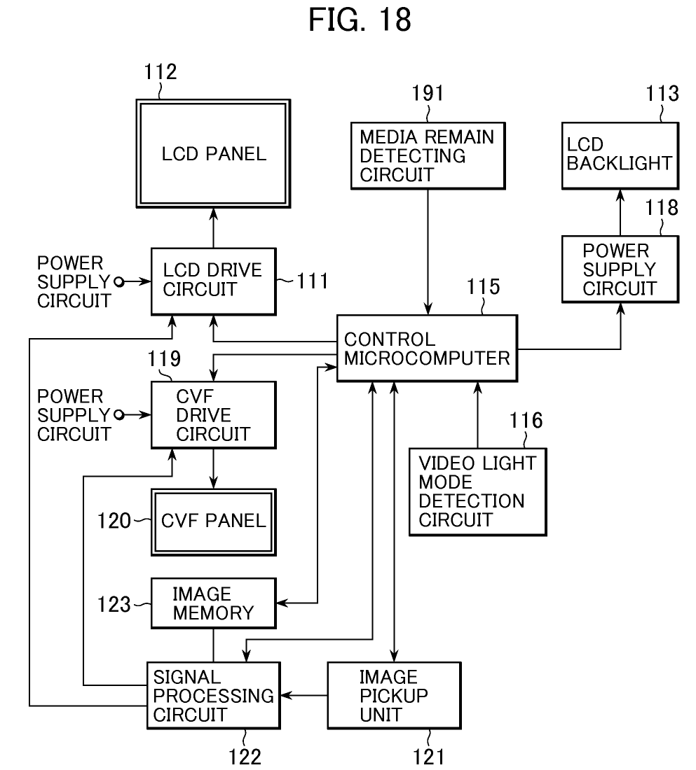

A method of releasing the video light mode in the image pickup apparatus of a tenth embodiment of the present invention is described below. FIG. 18 is a block diagram illustrating a configuration of a control circuit in a tenth embodiment of the present invention. The configuration of the image pickup apparatus according to the tenth embodiment is substantially the same as that in the sixth embodiment. The same composing elements as those described in the sixth embodiment are denoted with the same reference numerals and characters, and the descriptions thereof will be omitted. The configuration different from that in the sixth embodiment is described herein.

The control circuit is different from that in the sixth embodiment in that a media remain detecting circuit 191 (corresponding to a remain capacity detecting unit) is added to the control circuit to enable detecting the remain capacity of the recording medium. Incidentally, the opening and closing detecting switch 114 and the reversion detecting switch 117 in the sixth embodiment are omitted.

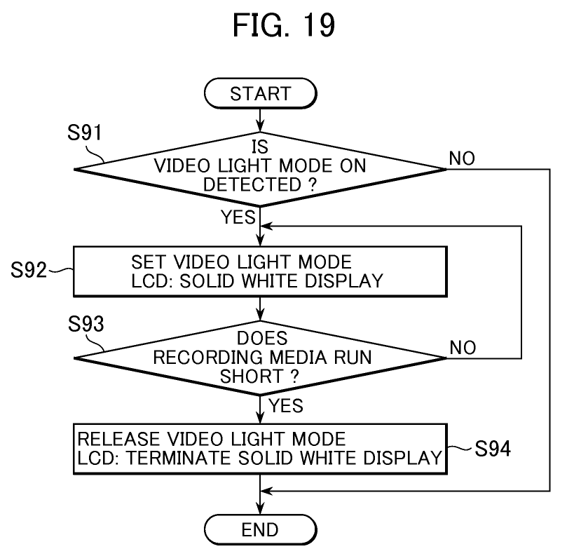

FIG. 19 is a flowchart illustrating the operational step of the video camera. The operation program is stored in a ROM (not shown) in the control microcomputer 115 and executed by a CPU (not shown) in the control microcomputer 115.

The control microcomputer 115 determines whether the video light mode detection circuit 116 detects that the video light mode is ON (step S91). If the video light mode detection circuit 116 detects that the video light mode is OFF, the control microcomputer 115 terminates the present process as it is.

If the video light mode detection circuit 116 detects that the video light mode is ON, the control microcomputer 115 changes over the display of the LCD panel 112 to the solid white (step S92). The control microcomputer 115 determines whether the capacity of the recording media detected by the media remain detecting circuit 191 runs short, that is to say, the remain capacity drops below a threshold value in the video light mode where the display of the LCD panel 112 is changed over to the solid white (step S93).

If it is detected that the capacity of the recording media runs short, the control microcomputer 115 releases the video light mode and causes the LCD panel 112 to terminate the display of the solid white (step S94). After that, the control microcomputer 115 terminates the present process.

If it is not detected that the capacity of the recording media runs short at step S93, the control microcomputer 115 returns to step S92 and holds the video light mode to keep the LCD panel 112 solidly white. After that, the control microcomputer 115 terminates the present process.

Thus, according to the tenth embodiment, if the capacity of the recording media runs short in the video light mode where the LCD panel displays the solid white, the video light mode is released to terminate the display of the solid white. Thereby, the user can easily understand the recording medium running short through the release of the video light mode, improving user friendliness.

### Eleventh Embodiment

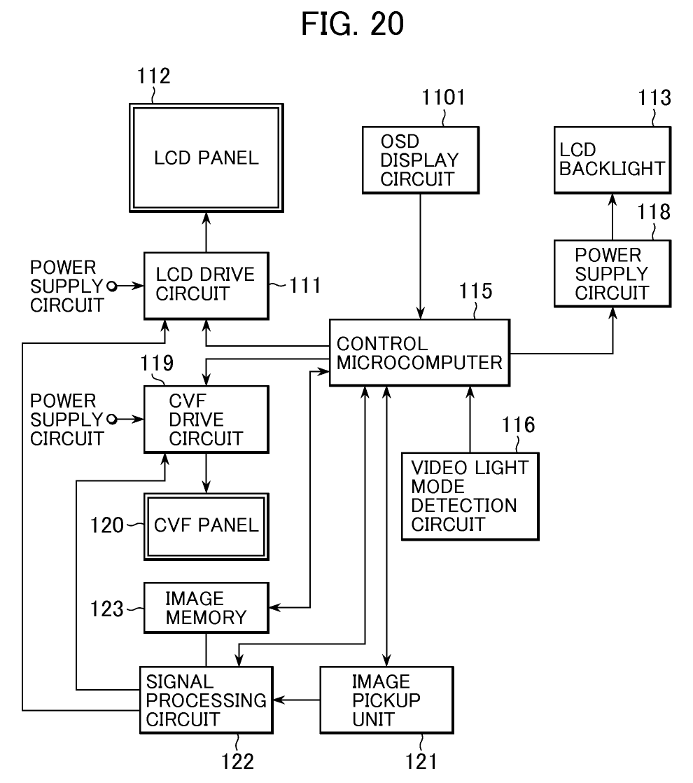

A method of releasing the video light mode in the image pickup apparatus of an eleventh embodiment of the present invention is described below. FIG. 20 is a block diagram illustrating a configuration of a control circuit in the eleventh embodiment. The configuration of the image pickup apparatus according to an eleventh embodiment of the present invention is substantially the same as that in the sixth embodiment. The same composing elements as those described in the sixth embodiment are denoted with the same reference numerals and characters, and the descriptions thereof will be omitted. The configuration different from that in the sixth embodiment is described herein.

The control circuit is different from that in the sixth embodiment in that an OSD display circuit 1101 is added to the control circuit to enable the OSD display on the LCD panel 112. Incidentally, the opening and closing detecting switch 114 and the reversion detecting switch 117 in the sixth embodiment are omitted.

In the sixth to tenth embodiments, the LCD panel 112 is rendered solidly white in the video light mode. In the eleventh embodiment, however, the contents indicating a method of releasing the video light mode is displayed on the LCD panel 112 by the on-screen-display (OSD) display. In the OSD display, a signal including contents indicating the method of releasing the video light mode is superposed on a signal indicating the solid-white display.

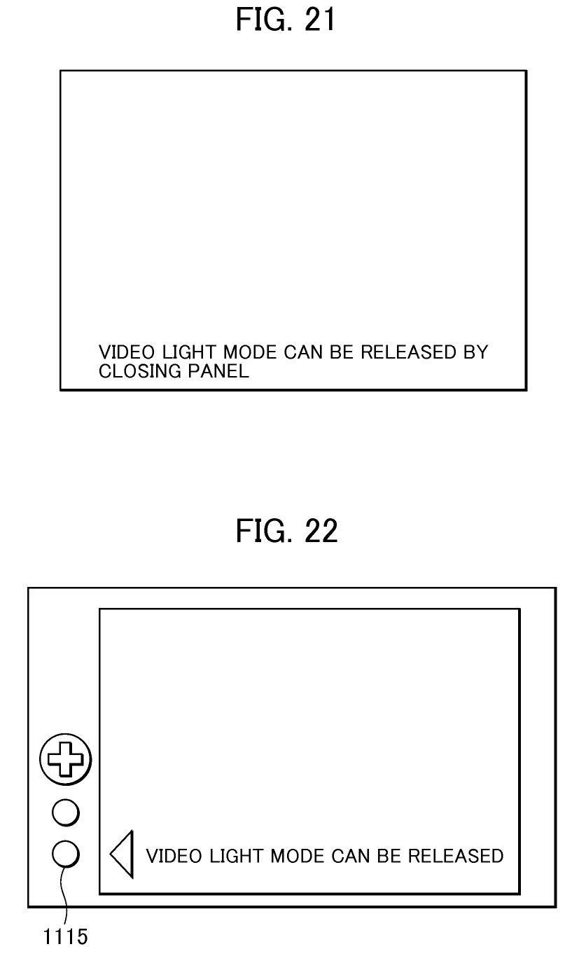

FIG. 21 is a chart illustrating one example of a screen of the LCD panel 112 which continues displaying the method of releasing the video light mode. The method of releasing the video light mode is continuously displayed in the video light mode. The text message of the method of releasing the video light mode displayed on the LCD panel 112 reads “The video light mode can be released by closing the panel.” Then, the video light mode is released upon the user's operation of closing the LCD panel 112 according to the contents indicating the method of releasing the video light mode, superposed on the screen of the solid white. Thus, the user can easily understand the method of releasing the video light mode. The contents indicating the method of releasing the video light mode are displayed on the LCD panel 112 may be displayed by not only a text, but also a picture.

FIG. 22 is a chart illustrating another example of the screen of the LCD panel 112 displaying the method of releasing the video light mode. A releasing button 1115 adapted to release the video light mode is arranged on the frame of the LCD panel 112. In this case, a message indicating the releasing button 1115 for releasing the video light mode by an arrow is displayed by a text and a picture on the LCD panel 112.

Thus, according to the image pickup apparatus of the eleventh embodiment, the contents indicating the method of releasing the video light mode are superposed on the display of the solid-white display in the video light mode where the LCD panel displays the solid white. Thereby, the user can easily understand the method of releasing the video light mode in any situation.

### Twelfth Embodiment

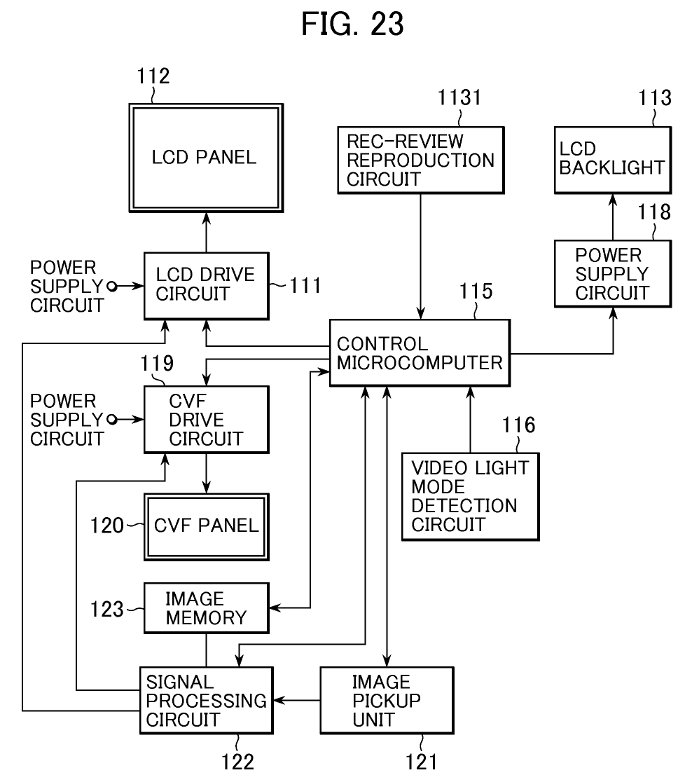

A method of releasing the video light mode in the image pickup apparatus of a twelfth embodiment of the present invention is described below. FIG. 23 is a block diagram illustrating a configuration of a control circuit in a twelfth embodiment of the present invention. The configuration of the image pickup apparatus according to the twelfth embodiment is substantially the same as that in the sixth embodiment. The same composing elements as those described in the sixth embodiment are denoted with the same reference numerals and characters to omit further description thereof. The configuration different from that in the sixth embodiment is described herein.

The control circuit is different from that in the sixth embodiment in that a rec-review reproduction circuit 1131 is added to enable a rec-review for confirming a picked-up image. Incidentally, the opening and closing detecting switch 114 and the reversion detecting switch 117 in the sixth embodiment are omitted.

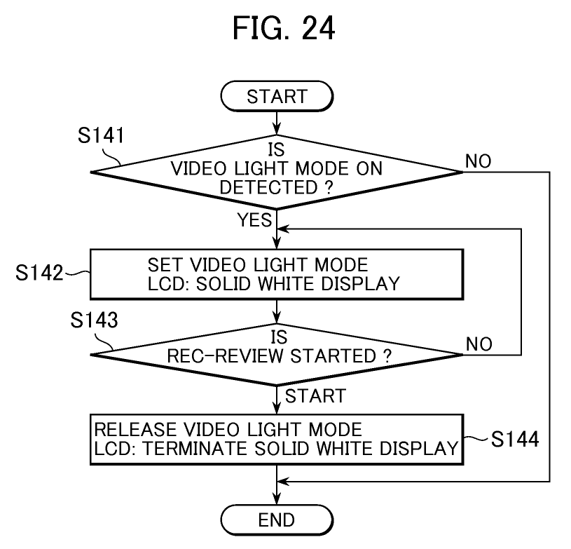

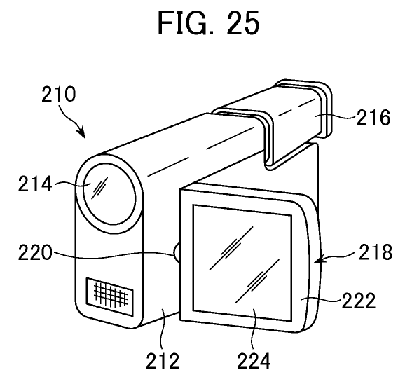

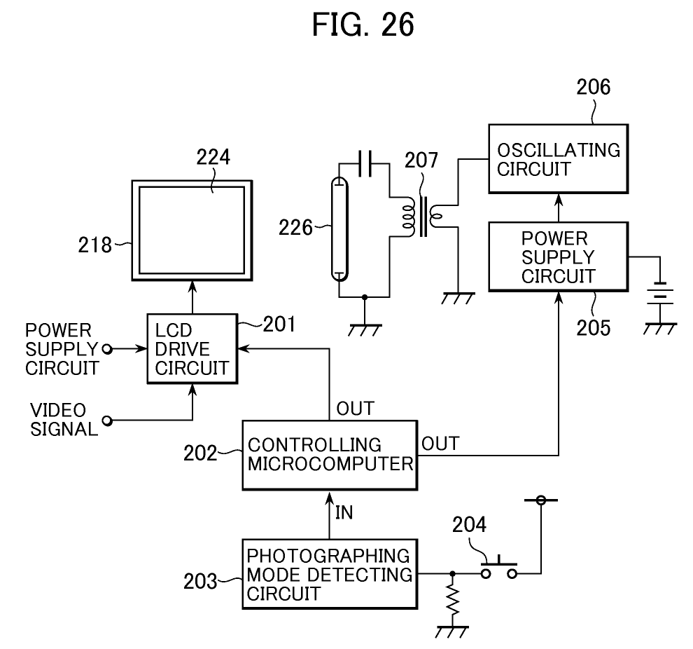

FIG. 24 is a flowchart illustrating the operational step of the video camera. The operation program is stored in a ROM (not shown) in the control microcomputer 115 and executed by a CPU (not shown) in the control microcomputer 115.

The control microcomputer 115 determines whether the video light mode detection circuit 116 detects that the video light mode is ON (step S141). If the video light mode detection circuit 116 detects that the video light mode is OFF, the control microcomputer 115 terminates the present process as it is.

If the video light mode detection circuit 116 detects that the video light mode is ON, the control microcomputer 115 changes over the display of the LCD panel 112 to the solid white (step S142). The control microcomputer 115 determines whether the rec-review reproduction circuit 1131 starts the rec review in the video light mode where the display of the LCD panel 112 is changed over to the solid white (step S143).

If the rec-review is started, the control microcomputer 115 releases the video light mode, causes the LCD panel 112 to terminate the display of the solid white (step S144) and terminates the present process.

If the rec-review is not started, on the other hand, the control microcomputer 115 returns to step S142 and holds the video light mode to keep the LCD panel 112 solidly white.

Thus, according to the twelfth embodiment, in the video light mode where the LCD panel displays the solid white, if the rec-review is started, the video light mode is released, and if the rec-review is completed, the process returns to the video light mode. This enables resuming the display of the solid white on the LCD panel in the video light mode and easily changing over the display on the LCD panel 112 to the reproduction of the picked-up image, making it easy to confirm the picked-up image.

The present invention is not limited to the configuration of the above embodiments, and may be applicable to any configuration that can achieve the functions described in the claims or possessed by the configuration of the present embodiment.

For example, although the luminance of the liquid crystal backlight is set to the standard luminance mode if the LCD panel is returned to the normal state and rendered to the reversed and closed state, the setting of the luminance does not need limiting to the above states. Specifically, the luminance of the liquid crystal backlight may be set to the standard luminance mode if the LCD panel is in any state where the LCD panel is not directed to the object, excluding the reversed state.

In the above embodiments, although the backlight LCD panel is used as a display apparatus, a spontaneous light emitting display apparatus such as an organic EL display may be used. Other than that, a surface-conduction electron-emitter display (SED) or a plasma display may be used.

In the above image pickup apparatus, although the liquid crystal panel is openably, closably and rotatably provided on the side of the camera main body, it is to be understood that the image pickup apparatus is not limited to the above structure. For example, the liquid crystal panel may be detachably attached to the front and the back face of the camera main body. In this case, attaching the liquid crystal panel to the front face of the camera main body enables using it as a video light.

Although the above embodiments exemplifies the case where the image pickup apparatus is applied to a video camera, it is needless to say that the image pickup apparatus may be applied to a digital still camera.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application Nos. 2007-286473 filed Nov. 2, 2007, 2007-286474 filed Nov. 2, 2007, and 2007-302127 filed Nov. 21, 2007, which are hereby incorporated by reference herein in its entirety.

1. An image pickup apparatus that images an object, comprising:
a first display unit adapted to display a video of the imaged object or solid white;
a second display unit adapted to display a video of the imaged object;
a selection unit adapted to select a video light mode of using said first display unit as a video light; and
a display controlling unit adapted to change over said first display unit so as to display the solid white instead of the video, and to turn on said second display unit to display the video if the video light mode is selected.

2. An image pickup apparatus according to claim 1, wherein said first display unit is disposed reversible so as to be directed to the object or a user of the image pickup apparatus,
said image pickup apparatus further comprises a reversing detecting unit adapted to detect that said first display unit is directed to the object or the user; and a superposing unit adapted to superpose a predetermined image on the video displayed,
and
wherein said superposing unit superposes the predetermined image on the video if it is detected that said first display unit is directed to the user, and said superposing unit does not superpose the predetermined image on the video if it is detected that said first display unit is directed to the object.

3. An image pickup apparatus according to claim 1, wherein said first display unit comprises a backlight liquid crystal panel and said second display unit is a view finder.

4. An image pickup apparatus according to claim 2, wherein the predetermined image superposed on the video is an image of a menu screen including a setting screen used for selecting the video light mode, and
said selection unit selects the video light mode by a predetermined menu operation on the displayed setting screen.

5. An image pickup apparatus according to claim 2, wherein the predetermined image superposed on the video is an image indicating a method of canceling the video light mode, and
said selection unit cancels the selection of the video light mode by a predetermined key operation performed according to the method of canceling the video light mode.

6. An image pickup apparatus according to claim 2, wherein the predetermined image superposed on the video is displayed by a menu screen including the setting screen used for selecting the video light mode and a screen indicating a video light mode canceling method, and
said selection unit selects the video light mode by a predetermined menu operation on the displayed setting screen and cancels the selection of the video light mode by a predetermined key operation performed according to the video light mode canceling method.

7. (canceled)

8. An image pickup apparatus that images an object, comprising:
a display unit moveably disposed so as to be selectively directed to the object and adapted to display a video of the imaged object or solid white;
a state detecting unit adapted to detect a first state where said display unit is directed to the object and a second state where the display unit is not directed to the object;
a selection unit adapted to select a video light mode of using said display unit as a video light;
a display controlling unit adapted to change over said display unit so as to display the solid white if the video light mode is selected;
a luminance adjusting unit adapted to adjust the luminance of said display unit; and
a luminance controlling unit adapted to control said luminance adjusting unit to lower the luminance of said display unit displaying the solid white when the second state is detected as compared with the luminance of the display unit displaying the solid white when the first state is detected.

9. An image pickup apparatus that images an object as claimed in claim 8, wherein the display unit is directed to a user of the image pickup apparatus in the second state.

10. An image pickup apparatus that images an object as claimed in claim 8 wherein, the display unit is disposed on a main body of the image pickup apparatus and is moveable between an open and close axis and rotatably about a rotation axis perpendicular to the open and close axis.

11. An image pickup apparatus according to claim 10, wherein said state detecting unit includes an open and close detecting unit adapted to detect an open and close state of said display unit openable and closable about an open and close axis with respect to the main body of the image pickup apparatus, and a rotation detecting unit adapted to detect a rotation state of the display unit rotatable about a rotation axis perpendicular to the open and close axis, and detects the state of the display unit based on the result detected by the open and close detecting unit and the rotation detecting unit.

12. An image pickup apparatus according to claim 10, wherein said display unit is a liquid crystal panel with a backlight and said luminance adjusting unit adjusts the luminance of the backlight.

13-15. (canceled)

16. An image pickup apparatus that images an object, comprising:
a display unit adapted to display a video of the imaged object or solid white;
a selection unit adapted to select a video light mode of using said display unit as a video light; and
a display controlling unit adapted to release the video light mode to terminate displaying of the solid white by said display unit if a specific condition occurs in a case where the video light mode is selected.

17. An image pickup apparatus that images an object as claimed in claim 16, further comprising:
an open and close detecting unit adapted to detect an open and close state of said display unit;
and
wherein the display controlling unit is adapted to change over said display unit so as to display the solid white if said open and close detecting unit detects that said display unit is opened in a case where the video light mode is selected, and to release the video light mode to terminate displaying of the solid white by said display unit if said open and close detecting unit detects that said display unit is closed in a case where the video light mode is selected.

18. An image pickup apparatus according to claim 17, further comprising a direction detecting unit adapted to detect that said display unit is directed to the object or a user of the image pickup apparatus, wherein
said display controlling unit cancels the video light mode to terminate displaying of the solid white by said display unit if said direction detecting unit detects that said display unit is directed to the user and said open and close detecting unit detects that said display unit is closed in a case where the video light mode is selected.

19. An image pickup apparatus that images an object as claimed in claim 16, further comprising:
an operation detecting unit adapted to detect that a key operation is performed on said image pickup apparatus;
a timing unit adapted to measure the elapsed time since the latest key operation is detected;
and
wherein the display controlling unit is adapted to change over said display unit so as to display the solid white if the video light mode is selected, and to release the video light mode to terminate displaying of the solid white by said display unit if the time measured by said timing unit exceeds a predetermined time.

20. An image pickup apparatus that images an object as claimed in claim 16, further comprising:
a recording medium detachably disposed in said image pickup apparatus and adapted to record the picked-up image;
an ejection detecting unit adapted to detect that said recording medium is ejected to the outside;
and
wherein the display controlling unit is adapted to change over said display unit so as to display the solid white if the video light mode is selected, and to release the video light mode to terminate displaying of the solid white by said display unit if said ejection detecting unit detects that said recording medium is ejected to the outside.

21. An image pickup apparatus that images an object as claimed in claim 16, further comprising:
a recording medium disposed in said image pickup apparatus and adapted to record the picked-up image;
a remain capacity detecting unit adapted to detect the remain capacity of said recording medium;
and
wherein the display controlling unit is adapted to change over said display unit so as to display the solid white if the video light mode is selected, and to release the video light mode to terminate displaying of the solid white by said display unit if said remain capacity detecting unit detects that the remain capacity of said recording medium drops below a threshold value.

22. An image pickup apparatus that images an object as claimed in claim 16, further comprising:
a superposing unit adapted to superpose contents indicating a video light mode canceling method on the changed over solid white, wherein
said display controlling unit cancels the video light mode to terminate displaying of the solid white by said display unit if a predetermined operation is performed in accordance with the superposed contents indicating a video light mode canceling method.

23-29. (canceled)

30. An image pickup apparatus that images an object, comprising:
a display unit adapted to display a video of the imaged object or solid white;
a rec-review reproduction unit adapted to reproduce the picked-up image;
a selection unit adapted to select a video light mode of using said display unit as a video light; and
a display controlling unit adapted to change over said display unit so as to display the solid white if the video light mode is selected, and release the video light mode to terminate displaying of the solid white by said display unit if said rec-review reproduction unit starts the rec-review, followed by returning to the video light mode to resume displaying of the solid white by said display unit if said rec-review reproduction unit terminates the reproduction of the image.

31. (canceled)
